(19) United States
(12) Patent Application Publication
(10) Pub. No.: US 2014/0156973 A1
(43) Pub. Date: Jun. 5, 2014

(54) PROCESSOR AND CONTROL METHOD OF PROCESSOR

(71) Applicant: FUJITSU LIMITED, Kawasaki-shi (JP)

(72) Inventor: Takashi SUZUKI, Kawasaki (JP)

(73) Assignee: FUJITSU LIMITED, Kawasaki-shi (JP)

(21) Appl. No.: 14/060,050

(22) Filed: Oct. 22, 2013

(30) Foreign Application Priority Data
Dec. 3, 2012 (JP) 2012-264654

(51) Int. Cl. G06F 9/38; G06F 9/30

(52) U.S. Cl. CPC G06F 9/38; G06F 9/30043
USPC 712/205

(57) ABSTRACT

A processor comprises an instruction fetch unit to acquire an instruction from an instruction address defined as an instruction storage source at a fetching stage of the processor repeating an instruction process including the fetching stage of fetching the instruction and an execution stage of executing the instruction, an associative relation storage unit to register an associative relation between a high-order bit field of the instruction address of the instruction undergoing the instruction process and high-order address information into which the high-order bit field of the instruction address is encoded, an encoding unit to encode the high-order bit field contained in the instruction address into the high-order address information on the basis of the associative relation and a decoding unit to decode the high-order bit field from the high-order address information and the associative relation.

### CROSS-REFERENCE TO RELATED APPLICATION

This application is based upon and claims the benefit of priority of the prior Japanese Patent Application No. 2012-264654, filed on Dec. 3, 2012, the entire contents of which are incorporated herein by reference.

### FIELD

The present invention relates to a processor and a control method of processor.

### BACKGROUND

A branch prediction mechanism of an information processing apparatus manages an execution history of branch instructions on the basis of storage addresses, on a memory, of instructions executed in the past. Then, the branch prediction mechanism predicts a branch destination in the case of executing the branch instruction next by managing the execution history of the branch instructions. The storage address of the instruction on the memory will hereinafter be referred to as an instruction address.

In the prediction of the branch destination, the branch prediction mechanism determines a set of storage devices in a set associative method from a bit field of a part of the instruction address of the branch instruction fetched from a storage source on the memory in the past. Hereinafter, a phrase “fetching the instruction from the memory” will be termed an “instruction fetch”. Further, the “instruction address of the branch instruction” is referred to as a branch source address. Then, the branch prediction mechanism stores the branch destination address in one way within the set determined from the bit field of the part thereof in a way that uses further another bit field of the branch source address as a tag.

Then, the branch prediction mechanism searches the storage device throughout by making use of the instruction address at an instruction fetch stage. Subsequently, when the branch destination address of the branch instruction executed already in the past is stored in the storage device, the branch prediction mechanism can obtain the branch destination address from the way with coincidence of a content of the tag within the relevant set. Namely, the branch prediction mechanism could determine in parallel with the instruction fetch whether or not the instruction to be fetched is the branch instruction, i.e., whether or not the branch destination address is stored in a way that uses a field of the instruction address of the branch source as the tag.

That is, in the technology described above, the information processing apparatus acquires the address of the instruction being fetched underway at the present, thereby determining in parallel with the instruction fetch whether the instruction to be fetched is the branch instruction or not. Then, the information processing apparatus can obtain the branch destination address to be predicted if the instruction is the branch instruction. Accordingly, the information processing apparatus can, even when executing a pipeline process, prepare the instruction fetch at a next stage from the branch destination to be predicted beforehand in parallel with the present instruction fetch.

Then, the information processing apparatus, if the branch destination obtained from the instruction being fetched underway at the present is a predicted branch destination, can perform parallel operations across the respective stages without stopping the pipeline process. Whereas if the branch destination obtained from the instruction being fetched underway at the present is not the predicted branch destination, it follows that the information processing apparatus resumes the instruction fetch from a correct branch destination. Further, when the branch destination is not stored in the storage device in the way of being associated with the instruction address of the branch instruction being fetched underway at the present, i.e., when the branch prediction does not hit, and nevertheless the branch instruction is executed, also the information processing apparatus cannot exploit the branch prediction. In this case, it follows that the information processing apparatus resumes the instruction fetch from the branch destination address obtained by decoding the branch instruction after being fetched.

By the way, in the information processing apparatus, a space to store the instructions has hitherto been a 32-bit address space. Corresponding to an increase in data size of the data to be processed, however, such an information processing apparatus exists as to extend a virtual address space to 64 bits. In such an information processing apparatus, not only the data space but also an instruction space takes a 64-bit configuration.

An actual program size is, however, far smaller than 4 GB given as a limit of a manageable size with 32-bit addresses. The program size is, even in the case of being comparatively large, e.g., about several hundred megabytes (MB). Accordingly, it can be said to be a futility of hardware resources that the branch prediction apparatus defined as a speculative execution processing unit is made to process the 64-bit address.

For example, it is efficient to apply the 64-bit configuration to only an inevitable portion defined in instruction set architecture. Such being the case, in the information processing apparatus, a control unit for controlling speculatively the instruction fetch based on a branch prediction has hitherto controlled the same instruction fetch as the conventional fetch by using only a low-order 32-bit address to the greatest possible degree.

A specific method is that the information processing apparatus fixes the high-order 32-bit address beforehand, and performs the instruction fetch by use of the fixed high-order 32 bits and a 4G byte space of the low-order 32 bits. Then, for instance, such a method is considered that if the branch destination address of the branch instruction exceeds the 4G byte space, the information processing apparatus redefines the high-order 32 bits.

Namely, the information processing apparatus normally fixes the high-order 32 bits of a program counter. Then, when an instruction to change the high-order 32 bits occurs, e.g., when the branch instruction, an exception, etc occur, the information processing apparatus obtains again the high-order 32 bits. Note that also when there occurs an event to change the high-order 32 bits of the program counter due to occurrence of an interrupt, the information processing apparatus executes the same processes. In this case, with completion of the instruction or the event to change the high-order 32 bits, it follows that the information processing apparatus temporarily clears thoroughly the pipeline containing the instruction fetch and the execution of the instruction.

Therefore, after rewriting the high-order 32 bits of the program counter into a new value, with the rewritten new address, the information processing apparatus resumes the processing from the instruction fetch. Accordingly, when there is the instruction or the event to change the high-order 32 bits, the information processing apparatus cannot enjoy a benefit of the speculative execution. Even if unable to enjoy the benefit of the speculative execution, as far as the program size is small, no problem is to arise. A reason why so is that an occurrence frequency of the instruction or the event to change the high-order 32 bits can be predicted not to be high to such a degree as to affect performance of the information processing apparatus.

There are, however, provided some of actual OSs (Operating Systems) which perform controlling by exploiting the high-order 32 bits of the 64-bit instruction address even in the case of the small program size to be allocated. Even in the case of the small program size to be allocated, in the information processing apparatus installed with the OS exploiting the high-order 32 bits, it is not improbable that the programs exist interspersed in the 64-bit virtual memory space. If so, even when the sizes of the individual programs are small, the branches over the 4 GB address of 32 bits can occur due to the branch instructions to a greater degree than expected.

The 64-bit address space is, however, configured corresponding to a convenience of the 64-bit extension of the data space, and hence instruction sequences are actually allocated to the addresses unevenly in the address space. This being the case, it is considered that the high-order 32 bits are expressed by a small number of bits in a pseudo manner by exploiting this unevenness. Namely, it may be sufficient that a pattern of the frequently occurring high-order addresses is taken into account, and the frequently occurring high-order addresses are expressed by fixed codes using the small number of bits. Herein, the “small number of bits” connotes bits that are smaller than a bit count of the high-order address. If the instruction sequences are actually allocated to the addresses unevenly, a change frequency of the high-order address is assumed to be low. Therefore, even when settling the fixed code of a small bit count that expresses each of these high-order addresses with respect to the plurality of high-order addresses fixed beforehand, an execution count of the branch instruction accompanying a change of the high-order address can be predicted to be small. Accordingly, the information processing apparatus can make the efficient branch prediction by using the fixed codes of the small bit count, which express the plurality of specified high-order addresses.

### DOCUMENTS OF PRIOR ARTS

### Patent Document

[Patent document 1] Japanese Laid-Open Patent Publication No. H06-089173
[Patent document 2] International Publication Pamphlet No. WO2007/099605
[Patent document 3] Japanese Laid-Open Patent Publication No. S63-147243

### SUMMARY

In the conventional technology, the information processing apparatus expresses the frequently occurring high-order address by the code of the small bit count. The information processing apparatus is based on the premise that the instruction sequences are allocated to the addresses unevenly. Therefore, if this premise is not satisfied, according to the conventional technology, it is difficult to execute processing efficiently. For example, if the programs allocated by the OS exist interspersed in a virtual 64-bit memory space, the frequently occurring high-order address becomes hard to be expressed by the code of the small bit count.

Under such circumstances, one aspect of the embodiment is exemplified by a processor. The processor includes an instruction fetch unit, an associative relation storage unit, an encoding unit, a decoding unit and a branch prediction unit. The instruction fetch unit fetches an instruction from an instruction address defined as an instruction storage source at a fetching stage of the processor repeating an instruction process including the fetching stage of fetching the instruction and an execution stage of executing the instruction. The associative relation storage unit registers an associative relation between a high-order bit field of the instruction address of the instruction undergoing the instruction process and high-order address information into which the high-order bit field of the instruction address is encoded. The encoding unit encodes the high-order bit field contained in the instruction address into the high-order address information on the basis of the associative relation. The decoding unit decodes the high-order bit field from the high-order address information on the basis of the associative relation.

The object and advantages of the invention will be realized and attained by means of the elements and combinations particularly pointed out in the claims. It is to be understood that both the foregoing general description and the following detailed description are exemplary and explanatory and are not restrictive of the invention.

### BRIEF DESCRIPTION OF THE DRAWINGS

FIG. 1 is a diagram illustrating an example of a structure of a high-order address table in a comparative example;

FIG. 2 is a flowchart illustrating a flow of executing a branch instruction;

FIG. 3 is a flowchart illustrating a problem in the case of updating the high-order address table in execution of the instruction underway;

FIG. 4 is a diagram illustrating system architecture according to one working example;

FIG. 5 is a diagram illustrating a configuration of a processor according to one working example;

FIG. 6 is a diagram depicting a flow of address information;

FIG. 7 is a flowchart illustrating a flow of a high-order address table updating operation;

FIG. 8 is a flowchart illustrating a problem in a case where there is no another-thread invalidation control that accompanies updating the high-order address table in an SMT method;

FIG. 9 is a flowchart illustrating a method of solving the problem that accompanies updating the high-order address table in the SMT method;

FIG. 10 is a diagram of a configuration of an H32 encoder;

FIG. 11 is a diagram of a configuration of an H32 decoder;

FIG. 12 is a diagram of a configuration of a high-order address switchover determining unit.

### DESCRIPTION OF EMBODIMENTS

An information processing apparatus according to one embodiment will hereinafter be described with reference to the drawings. A configuration of the following embodiment is an exemplification, and the present apparatus is not limited to the configuration of the embodiment.

### Comparative Example

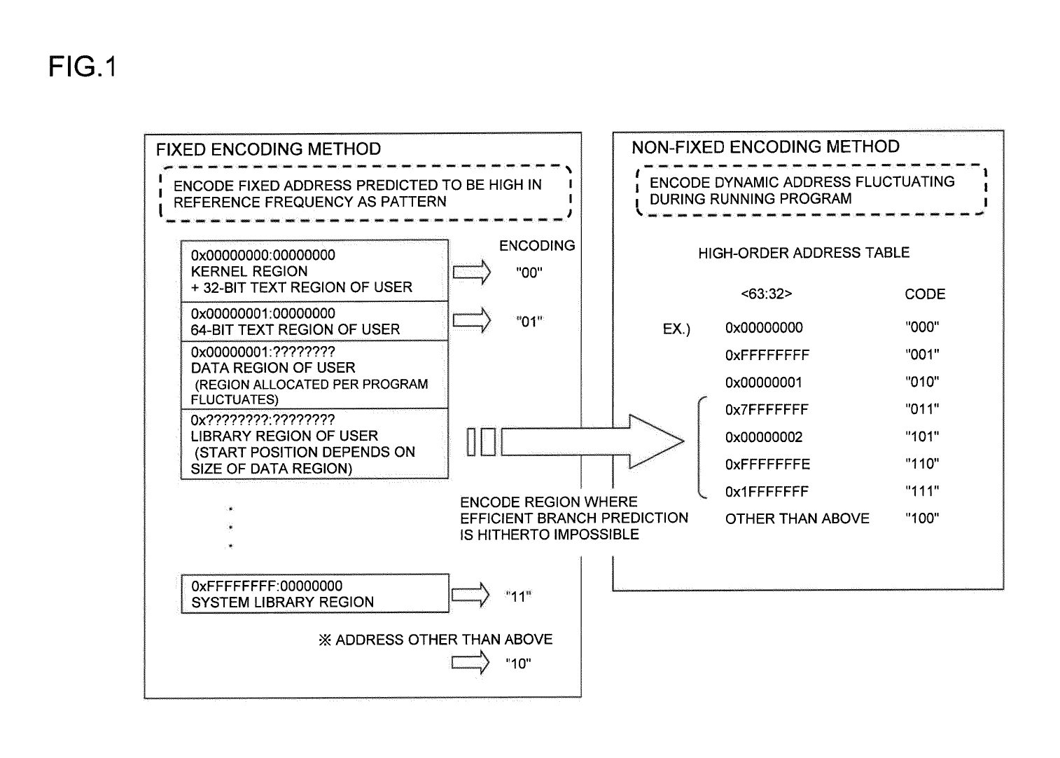

An information processing apparatus according to a comparative example will hereinafter be described with reference to FIGS. 1 through 3. The information processing apparatus according to the comparative example has, e.g., a 64-bit virtual address space. Herein, in the 64-bit addresses, high-order 32 bits are called high-order addresses, while low-order 32 bits are called low-order addresses.

Further, the information processing apparatus in the comparative example encodes a 32-bit high-order address into a code of a smaller bit count than 32 bits. Furthermore, the information processing apparatus in the comparative example is provided inside with a high-order address table. The high-order address table is a table to store an associative relation between the high-order address processed by the information processing apparatus and the code of the small bit count. The high-order address table has entries each identified by the code of the smaller bit count than 32 bits, e.g., identified by a 3-bit code. The information processing apparatus in the comparative example, whenever processing a new high-order address, registers this new high-order address in the high-order address table. Herein, the “new high-order address” connotes a high-order address not registered in the high-order address table.

The information processing apparatus in the comparative example, when registering the high-order address in the high-order address table, describes the high-order address by use of, in place of the 32 bits of the high-order address, a code of the small bit count associated with the entry in the high-order address table in which this high-order address is registered. Namely, the information processing apparatus in the comparative example registers the high-order address in the high-order address table dynamically during running a program, thereby updating the associative relation of the high-order address with the code of the small bit count. For instance, when the information processing apparatus in the comparative example further registers a high-order address not registered in a status with no free space in the high-order address table, the information processing apparatus overwrites the not-registered high-order address to the entry in which the existing high-order address has already been registered. Accordingly, the information processing apparatus in the comparative example is capable of switching over the high-order address to be encoded dynamically during running the program.

FIG. 1 illustrates a comparison between a method of encoding the high-order address with a conventional fixed code and a method of encoding the high-order address dynamically with a non-fixed code in the information processing apparatus in the comparative example. The encoding method using the fixed code in FIG. 1 is that the information processing apparatus encodes a fixed high-order address predicted to exhibit a high reference frequency with the bit count smaller than a bit count of the high-order address.

In the example of FIG. 1, e.g., a region of a high-order address “0x00000000” is exemplified as a kernel region in a 64-bit address space and as a 32-bit user text region.

Moreover, e.g., a region of a high-order address “0x00000001” is exemplified as a 64-bit user text region in the 64-bit address space, and a region subsequent to the text region is exemplified as a data region of the user. The data region of the user could be fluctuated in terms of ensuring a region for every program.

Further, for example, a region of a high-order address “0xFFFFFFFF” is exemplified as a system library region in the 64-bit address space.

Note that a region subsequent to the 64-bit data region of the user is exemplified as a library region of the user. A start position of the library region of the user depends on a size of the data region and is therefore noted such as “0x????????:????????” in the drawing. Herein, a left side of “:” (colon) indicates the high-order address, while a right side of the colon indicates the low-order address. Further, the symbol “?” represents an arbitrary hexadecimal value.

A conventional fixed encoding scheme involves fixedly allocating codes “00”, “01”, “11” to the high-order addresses “0x00000000”, “0x00000001” and “0xFFFFFFFF”. Accordingly, for instance, a branch prediction cannot be efficiently done in the user library region where the start position fluctuates. This is because it is difficult to determine which high-order address the fixed code is allocated to.

Such being the case, the information processing apparatus in the comparative example performs the non-fixed encoding. In the non-fixed encoding method in FIG. 1, the information processing apparatus prepares 7 entries associated with 3-bit codes by way of the high-order address table. Then, the information processing apparatus, when recognizing the high-order address not registered in the high-order address table during running the program, registers the recognized high-order address in the high-order address table. Then, the information processing apparatus allocates the codes associated with the entries with the high-order addresses being registered to the registered high-order addresses.

For example, in the example of FIG. 1, the code “000” is allocated to the high-order address“0x00000000”. Moreover, e.g., the code “001” is allocated to the high-order address“0xFFFFFFFF”.

That is, in the case of the high-order address table illustrated in FIG. 1, the information processing apparatus uses, e.g., the code “000” in place of the high-order address“0x00000000”. Further, the information processing apparatus uses the code “001” in place of the high-order address “0xFFFFFFFF”.

Thus, the information processing apparatus can employ the 3-bit code in place of using the 32-bit high-order address with respect to the high-order address registered in the high-order address table. Moreover, the high-order addresses not registered in the high-order address table are encoded in a batch to, e.g., a code “100”.

Further, after the high-order addresses have been registered in all of the entries, in the case of FIG. 1, e.g., seven entries of the high-order address table, the information processing apparatus, when recognizing the new high-order addresses, registers these new high-order addresses while deleting the already-registered high-order addresses, i.e., overwriting these already-registered high-order addresses sequentially with the new high-order addresses. Then, the information processing apparatus encodes the seven high-order addresses in the way of being associated respectively with seven codes, i.e., the seven pieces of 3-bit data by use of the high-order address table in FIG. 1. In the manner described above, the information processing apparatus encodes the high-order addresses in a way that switches over the high-order addresses to be registered in the high-order address table dynamically during running the program, and executes a process such as the branch prediction by employing the codes associated with the high-order addresses and the low-order addresses.

When switching over the codes associated with the high-order addresses dynamically during running the program, however, a following problem arises. For example, a determination as to whether the branch prediction gets successful or unsuccessful is made based on whether or not a branch destination address calculated is coincident with an address given when making the branch prediction. Hereinafter, an assumption in the present comparative example is that the branch destination address is what the low-order address is combined with the code of the high-order address.

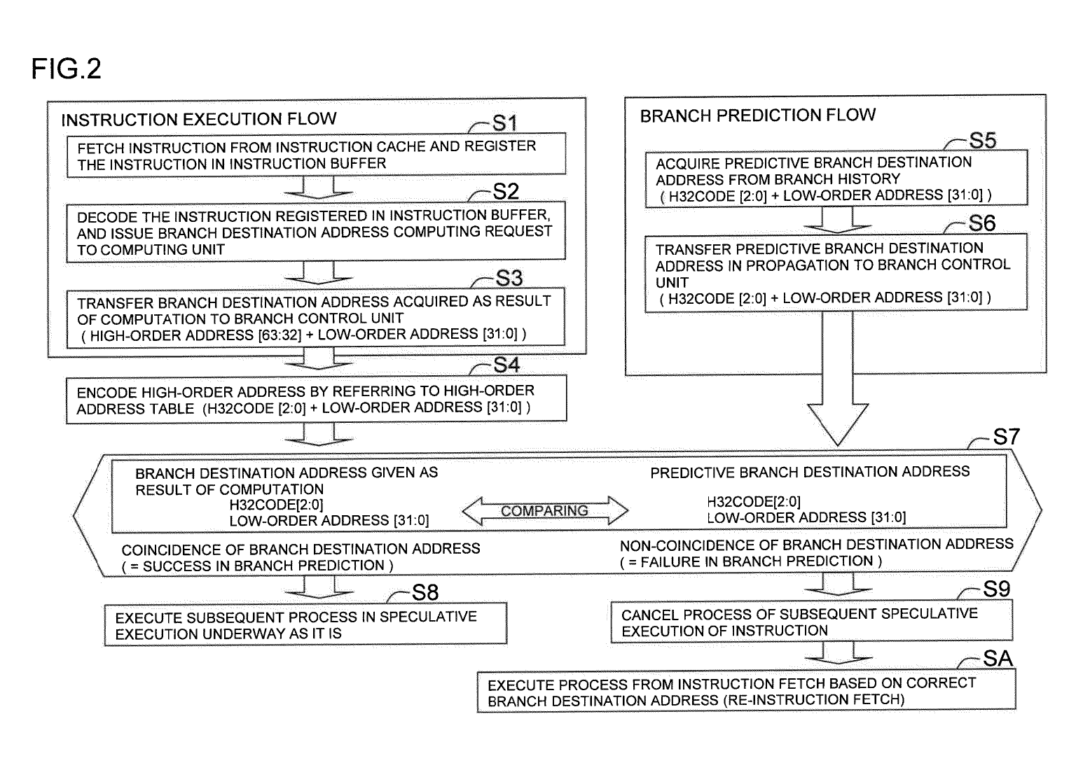

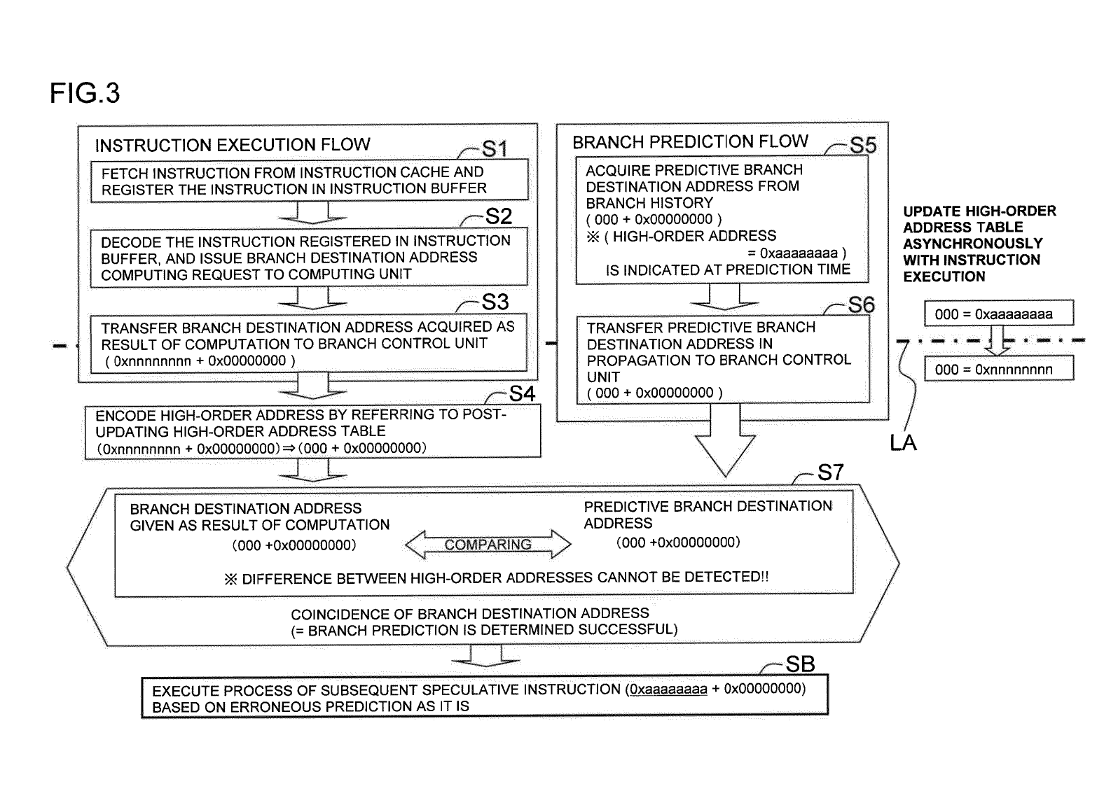

FIGS. 2 and 3 are flowcharts each illustrating a flow of executing a branch instruction. FIG. 2 illustrates an execution flow reaching the execution of the instruction from an instruction fetch, a branch prediction flow of a branch prediction unit and a flow of verifying coincidence of an arithmetic result of a branch control unit with the branch prediction.

In the instruction executing flow in FIG. 2, the information processing apparatus fetches the instruction from an instruction cache and registers the fetched instruction in an instruction buffer (S1). Next, the information processing apparatus decodes the instruction registered in the instruction buffer, and issues a branch destination address computing request to a computing unit (S2). Then, the information processing apparatus transfers the branch destination address acquired as a result of the computation in the computing unit to the branch control unit (S3). The branch destination address transferred to the branch control unit is a 64-bit address (the high-order address [63:32]+the low-order address [31:0]). The branch control unit of the information processing apparatus encodes the high-order address by referring to the high-order address table, and generates a high-order address code H32CODE [2:0]. Then, the information processing apparatus combines the high-order address code H32CODE[2:0] with the low-order address [31:0] (H32CODE[2:0]+low-order address [31:0]), thereby generating the branch destination address as the result of the computation.

On the other hand, in the branch prediction flow of the information processing apparatus, the information processing apparatus acquires a predictive branch destination address from a branch history (S5). The predictive branch destination can be described by a combination of the high-order address code and the low-order address such as H32CODE[2:0]+low-order address [31:0]. Then, the information processing apparatus transfers the predictive branch destination address acquired from the branch history to the branch control unit (S6).

The branch control unit of the information processing apparatus compares the branch destination address as the result of the computation that is acquired from the instruction execution flow with the predictive branch destination address acquired from the branch prediction flow (S7). Subsequently, if the branch destination address as the result of the computation is coincident with the predictive branch destination address, the information processing apparatus determines that the branch prediction gets successful. Thereupon, the information processing apparatus continues a process of a subsequent instruction undergoing a speculative execution as it is (S8).

Whereas if it is determined in S7 that the branch destination address as the result of the computation is not coincident with the predictive branch destination address, the information processing apparatus determines that the branch prediction gets unsuccessful. Thereupon, the information processing apparatus cancels the process of the subsequent instruction undergoing the speculative execution (S9). Then, the information processing apparatus executes the processes from the instruction fetch on the basis of a correct branch destination address, i.e., the branch destination address given as the result of the computation (SA). In the case of a failure in the branch prediction, the instruction fetch from the correct branch destination address is also called a re-instruction fetch.

FIG. 3 is the flowchart illustrating a result in a case where the code of the high-order address is updated during a period from a stage of the branch prediction to a stage of calculating the branch destination in FIG. 2. Processes illustrated in FIG. 3 are the same as those in FIG. 2. In FIG. 3, however, one-dotted chain line LA is depicted within the processing flow, which implies that contents of the high-order address table are updated before and after the one-dotted chain line LA.

For example, when the information processing apparatus processes a certain branch instruction on the basis of pipeline processing, it is assumed that a code “000” is to be registered in the high-order address table as a code of a high-order address “0xaaaaaaaa” at a branch prediction stage. It is further assumed that the code of the high-order address is updated during a period from the branch prediction stage to the branch destination calculation stage. For instance, the code “000” is assumed to be registered in the high-order address table as a code of a high-order address “0xnnnnnnnn”.

If the assumptions described above are established, the high-order address “0xaaaaaaaa” of the branch prediction address is encoded to the code “000” when making the branch prediction. Also if the high-order address given as the calculation result of the branch destination is “0xnnnnnnnn”, however, the high-order address is encoded to “000”.

Thus, even when the code of the high-order address is the same, the high-order address differs with respect to the address when making the branch prediction and the address given as the calculation result of the branch destination. Namely, if determined based on the high-order address, the branch prediction gets unsuccessful due to non-coincidence of the branch destination address. Accordingly, it follows that the information processing apparatus, in the process not using the code of the high-order address, cancels the instruction undergoing the speculative execution for the branch prediction, and resumes the instruction fetch on the basis of the calculated branch destination address.

In the case of the processes illustrated in FIG. 3, however, both of the code of the high-order address of the branch prediction address and the code of the high-order address of the address given as the calculation result of the branch destination are “000”. Therefore, the information processing apparatus cannot detect the non-coincidence of the branch destination address. Thus, if the code for the high-order address is updated and if the high-order address when making the branch prediction is erased, the information processing apparatus cannot decode the original high-order address that has been initially encoded. It is therefore difficult for the information processing apparatus to detect the non-coincidence of the high-order address.

If unable to detect the non-coincidence of the high-order address, the information processing apparatus cannot determine the failure in the branch prediction. As a result, in the information processing apparatus, the process advances as it is without cancelling the instruction of the speculative execution that should be originally cancelled (SB). It therefore follows that there is implemented an instruction different from the instruction conforming to processing of a program executed by the information processing apparatus, and such a possibility exists that values of, e.g., a register and a memory are to be broken.

Moreover, in the case of applying the processes in the comparative example to a multi-thread processor, a following problem arises. Herein, the multi-thread processor connotes a processor configured to enable resources of a computing device etc to be shared between a plurality of programs by multiplexing the registers within the single processor. When the programs run in parallel on the multi-thread processor, bit patterns of the high-order addresses frequently occurring are predicted to be similar to each other. Therefore, if the patterns of the high-order addresses can be shared between threads, it is considered that a further efficient branch prediction can be attained.

When thinking of a case in which the codes of the high-order addresses are shared between the threads and dynamically switched over on the multi-thread processor, a switchover timing thereof is considered also independent on a thread-by-thread basis. As a result, it is considered more difficult to detect the non-coincidence of the high-order address than by a single thread.

### Examples

In the embodiment, the information processing apparatus includes an encoding unit and a decoding unit. The encoding unit has the associative relation between the high-order addresses and the codes in the high-order address table, and encodes the high-order address to the code having the small bit count on the basis of the high-order address table. In the embodiment, the code, into which the high-order address is encoded based on the high-order address table, will hereinafter be referred to also as high-order address information. The decoding unit decodes the high-order address information having the small bit count back to the high-order address on the basis of the same table.

The information processing apparatus further includes a branch prediction unit, an instruction fetch control unit and a branch control unit. The branch prediction unit registers a set of the high-order address information having the small bit count and the low-order address as an address. The instruction fetch control unit generates an instruction address by combining the high-order address, into which the high-order address information obtained from the branch prediction unit is decoded by the decoding unit, with the low-order address obtained from the branch prediction unit. Then, the instruction fetch control unit performs the instruction fetch on the basis of this instruction address. The branch control unit decodes the branch instruction from the fetched instruction code, then calculates the branch destination address and verifies the coincidence between the calculated branch destination address and the branch destination address given when making the branch prediction. Subsequently, the branch control unit determines whether the branch prediction gets successful or unsuccessful.

In the embodiment, the information processing apparatus updates the high-order address table registered with the high-order addresses, and switches over the associative relation between the high-order addresses to be coded and the codes, i.e., the high-order address information dynamically during running the program. As explained in the comparative example, when the high-order address table is updated in the course of executing the branch instruction, it is difficult to detect the non-coincidence between the high-order address given when making the branch prediction and the high-order address given when calculating the branch destination address. Therefore, the information processing apparatus restricts the update timing of the high-order address table, i.e., the timing of switching over the associative relation between the high-order addresses to be coded and the codes. Namely, the information processing apparatus according to the embodiment assures the coincidence between the high-order address and the code into which the high-order address is encoded when making the branch prediction and when calculating the branch destination address by restricting the update timing of the high-order address table.

<Examination of Assuring Associative Relation Between High-Order Address and Code>

In the embodiment, to start with, such a case is examined that the high-order address of the branch destination gets disabled from being decoded. For making the examination with respect to the high-order address of the branch destination, such a case is herein assumed that the information processing apparatus executes the branch instruction.

For example, when the high-order address of the branch destination is registered in the high-order address table, the information processing apparatus can calculate the high-order address of the branch destination from the code by referring to the high-order address table. Further, if an address with no change of the high-order address indicates the branch destination, the information processing apparatus can calculate the high-order address by referring to a program counter indicating the address of the instruction in the execution underway.

Accordingly, the case where the high-order address of the branch destination cannot be calculated is a case in which the high-order address of the branch destination is the high-order address not registered in the high-order address table and is different from the address of the instruction in the execution underway.

In the embodiment, the information processing apparatus allocates a code (e.g., “x”), different from the codes allocated to the registered high-order addresses, to the high-order address not registered in the high-order address table. Then, the information processing apparatus, if the code of the high-order address information given when calculating the branch destination address is “x” and if the high-order address of the branch destination is different from an address indicated by the program counter, determines that the branch destination address is not coincident. That is, when the high-order address of the branch destination is not registered in the high-order address table and when the high-order address of the branch destination, which is calculated by the computing unit, is not coincident (occurrence of the branch exceeding 4 GB) with the high-order address of an instruction address of a branch source (program counter value), the information processing apparatus determines that the branch destination address is not coincident with the predictive branch destination address.

Then, the information processing apparatus performs control to cancel the speculative execution of the instruction and to update the program counter with the branch destination address calculated by the computing unit. When the program counter is updated, the information processing apparatus gets enabled to calculate the high-order address from a value of the updated program counter. Thereupon, the information processing apparatus generates the high-order address from the updated program counter, and can resume the instruction fetch based on a correct address containing the generated high-order address.

Further, in the embodiment, the high-order address table is updated at such a timing as to enable the assurance that the high-order addresses associated with the codes are coincident when making the branch prediction and when calculating the branch destination address. Such being the case, in the embodiment, the information processing apparatus exploits an opportunity of canceling the speculative execution of the instruction due to the failure in the branch prediction. The cancellation of the speculative execution of the instruction is a process of resuming the processing from the instruction fetch defined as a first stage of the pipeline by cancelling all the executions of the instructions existing so far. Then, the information processing apparatus updates the high-order address table at the timing of cancelling the speculative execution of the instruction due to the failure in the branch prediction.

The information processing apparatus, for instance, upon completing the execution of the branch instruction when the high-order address of the branch destination is not registered in the high-order address table as described above, cancels the speculative execution of the instruction. At the timing of cancelling the speculative execution of the instruction, the information processing apparatus registers the high-order address of the branch destination of the instruction with its execution being completed in the high-order address table, thus updating the high-order address table. After cancelling the speculative execution of the instruction, the processing resumes from the instruction fetch of the branch destination address, and hence the information processing apparatus can assure that the associative relation between the high-order address to be encoded and the code is identical when making the branch prediction and when calculating the branch destination address at the time of executing the subsequent instruction. Note that the speculative execution of the instruction is cancelled, e.g., in addition to the case where the high-order address of the branch destination is not registered in the high-order address table, in a case where the low-order address is not coincident, i.e., the normal branch prediction gets unsuccessful, a case of detecting an exception and a case where an interrupt occurs.

In the case of conducting the instruction process with the single thread, the information processing apparatus can assure the associative relation between the high-order address to be encoded and the code also in the case of updating the high-order address table dynamically during running the program under the control to update the high-order address table at the timing described above. In the case of a processor taking a multi-threading method, especially, a simultaneous multi-threading (SMT) method and having a configuration to share the pattern of the high-order address to be encoded between the threads, however, the processing becomes complicated. The simultaneous multi-threading connotes a technique, a process, etc, in which a single CPU (Central Processing Unit) simultaneously executes a plurality of threads in parallel.

According to the SMT method, the timing of cancelling the speculative execution of the instruction can occur on the thread-by-thread basis without any dependency. Therefore, when executing the switchover of the associative relation between the high-order address to be encoded and the code at the timing of cancelling the speculative execution of a certain thread “a” as described above, there is a possibility that the timing of switching over the associative relation exists in executing the branch instruction of another thread “b” underway. In this case, the information processing apparatus cannot assure the coincidence of the encoded pattern between when making the branch prediction of another thread “b” and when calculating the branch destination address.

This being case, in the embodiment, the information processing apparatus assures an operation of another thread when the high-order address table is updated with a certain thread when operating the plurality of threads. It is assumed that another thread undergoes the execution of the instruction underway when the high-order address table is updated by the branch instruction of a certain thread “a”. In such a case, the information processing apparatus encodes the high-order address to “x” irrespective of whether or not the high-order address of the branch destination is registered in the high-order address table with respect to the branch instruction of another thread “b”. Herein, the symbol “x” represents the code associated with the high-order address not registered in the high-order address table.

The information processing apparatus, when the code of the high-order address information is “x” and if the high-order address of the branch destination changes, determines that the branch destination address given when making the branch prediction is not coincident with the branch destination address given when calculating the branch destination address under the control described above. Therefore, the information processing apparatus detects the non-coincidence of the branch destination address in the thread “b”. When the non-coincidence of the branch destination address is detected, the speculative execution of the instruction of the thread “b” is cancelled, and the instruction fetch resumes. It is therefore feasible to assure the coincidence of the associative relation between the high-order address to be encoded and the code when making the branch prediction and when calculating the branch destination address when and after cancelling the speculative execution of the instruction also in the thread “b”. The information processing apparatus makes the branch prediction based on the high-order address table updated with the thread “a” when the instruction fetch resumes in the thread “b”. Accordingly, the information processing apparatus can make the efficient branch prediction in a way that shares the dynamic associative relation between the high-order address and the code between the threads during running the program.

Thus, the information processing apparatus in the embodiment obviates the arising problem by switching over the associative relation between the high-order address to be encoded and the code dynamically during running the program. The information processing apparatus enables the high-order 32-bit address frequently occurring in the 64-bit address space to be expressed by the small number of bits and further enables the converting method into the small number of bits to be switched over during running the program. Accordingly, the information processing apparatus can realize the efficient branch prediction based on a small quantity of hardware resources.

<Hardware Configuration>

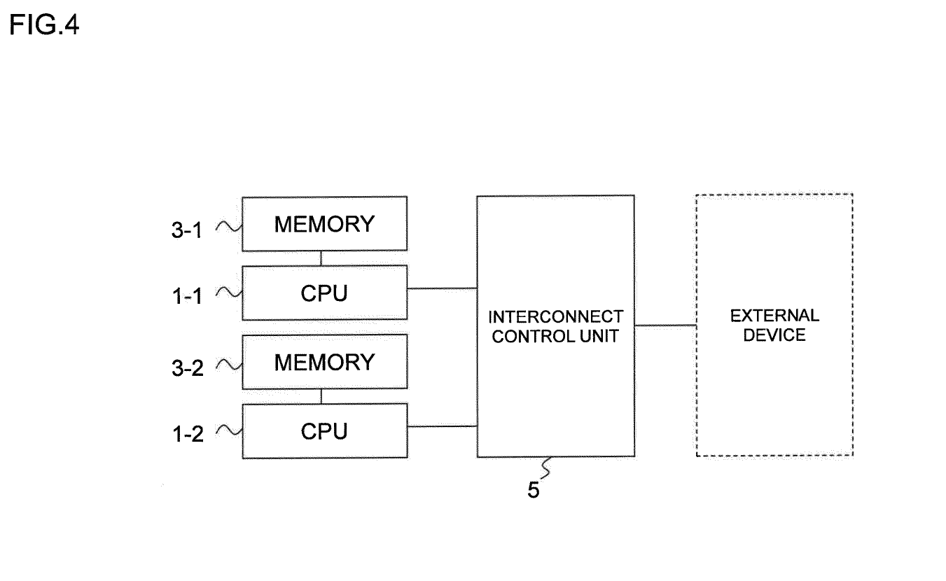

FIG. 4 illustrates system architecture of the information processing apparatus according to one working example. FIG. 4 depicts a system of a server etc including a processor to which the present working example is applied. The information processing apparatus in FIG. 4 includes a plurality of processors (CPUs) 1-1 and 1-2, memories 3-1 and 3-2, and an interconnect control unit 5 which performs input/output control with an external device. Herein, the processors 1-1, 1-2, etc are generically simply termed the processor 1. Incidentally, it does not mean that the number of processor(s) is limited to “1” in the information processing apparatus of FIG. 4.

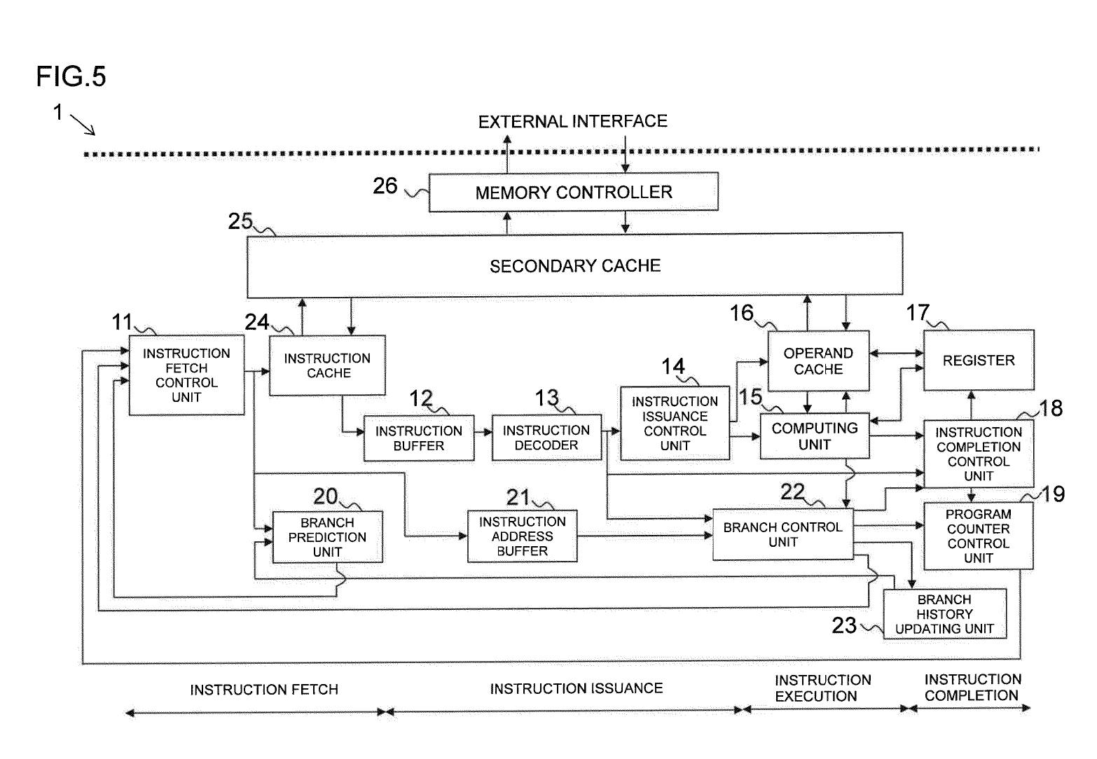

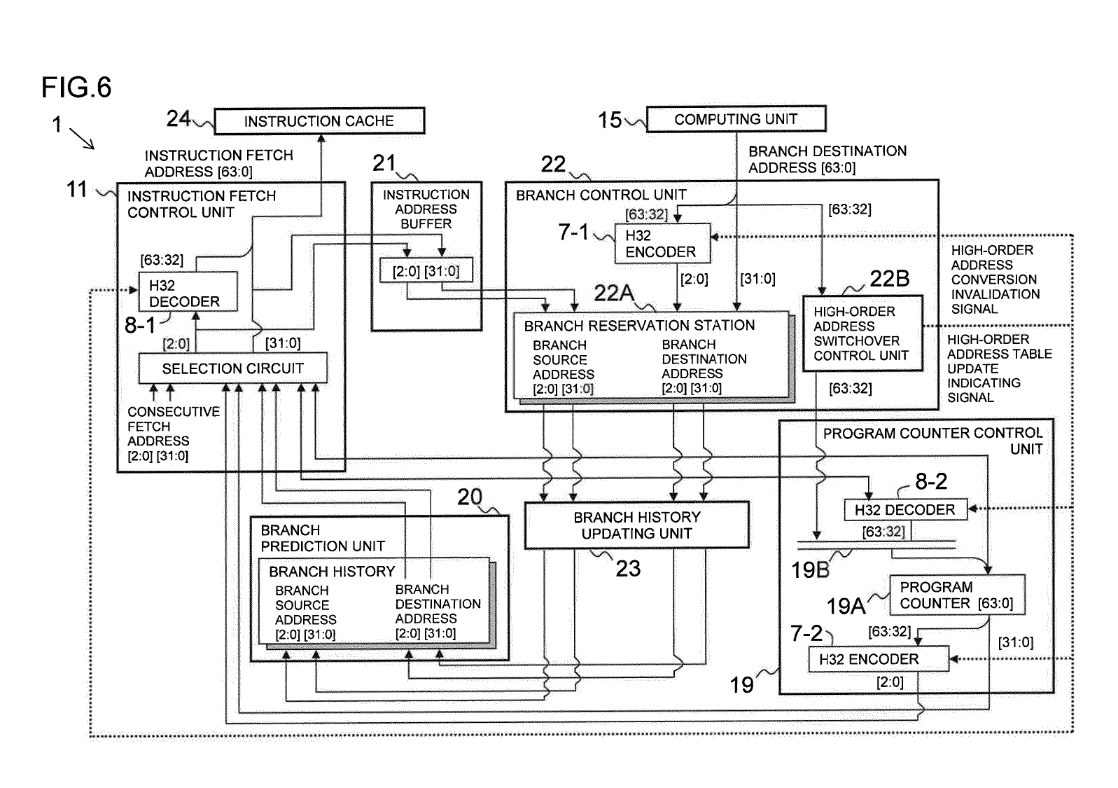

FIG. 5 depicts a configuration of the processor 1. Further, FIG. 6 illustrates a flow of address information used for the instruction fetch. In the working example, out-of-order execution and a general-purpose processor having a pipeline function are assumed. Note that sequential execution as written in the program is referred to as in-order execution. On the other hand, the out-of-order execution is defined as a technology of expanding a possibility of simultaneously executing a plurality of instructions in such a manner that the processor executes an executable instruction in an execution procedure different from the execution procedure written to the program, e.g., in advance of the execution procedure written to the program.

FIG. 5 illustrates an “instruction fetch” stage, an “instruction issuance” stage, an “instruction execution” stage and an “instruction completion” stage. FIG. 5 depicts a relation between the respective stages and components operating at the respective stages. For example, an instruction fetch control unit 11, an instruction buffer 12, a branch prediction unit 20, a (primary) instruction cache 24 and a secondary cache 25 operate at the instruction fetch stage.

The instruction fetch control unit 11 acquires the predictive branch destination address of the instruction to be fetched from the branch prediction unit 20. Further, the instruction fetch control unit 11 acquires the branch destination address established by the branch computation from the branch control unit 22. Furthermore, the instruction fetch control unit 11 acquires the program counter value defined as an address of the instruction completed next from a program counter control unit 19. The instruction fetch control unit 11 is one example of an instruction fetch unit.

Moreover, the instruction fetch control unit 11 generates a next address for consecutively fetching the instructions if not branched within the instruction fetch control unit 11. The instruction fetch control unit 11 establishes the next instruction fetch address by making a selection from the predictive branch destination address acquired as described above, the program counter value and the thus-generated next address.

The instruction fetch control unit 11 outputs the established instruction fetch address to the instruction cache 24, and fetches an instruction code from the thus-output instruction fetch address. The instruction cache 24 is the primary cache to store a part of data of the secondary cache 25. Further, the secondary cache 25 stores a part of data of, e.g., the memory 3-1 (see FIG. 4) etc. If the data of the relevant address does not exist in the instruction cache 24 defined as the primary cache, the data is acquired into the instruction cache 24 from the secondary cache 25. Furthermore, if the relevant data does not exist in the secondary cache 25, the data is acquired into the secondary cache 25 from the memory 3-1 etc.

In the working example, the memory 3-1 etc is disposed outside the processor 1. Therefore, the I/O control between the external memory 3-1 etc and the processor 1 is carried out via a memory controller 26. Instruction codes fetched from the relevant addresses of the instruction cache 24, the secondary cache 25, the memory 3-1 etc are stored in the instruction buffer 12.

The branch prediction unit 20 executes the branch prediction in parallel with the instruction fetch. The branch prediction unit 20 receives an instruction fetch address output from the instruction fetch control unit 11. Then, the branch prediction unit 20 makes the branch prediction based on the received instruction fetch address, and sends back a branch direction indicating whether the branch is set up or not and the branch destination address to the instruction fetch control unit 11. The instruction fetch control unit 11, if the predicted branch direction is set up, selects the branch destination address predicted as a next instruction fetch address. Hereafter, the speculative execution of the instruction advances with the predicted branch destination address.

At the instruction issuance stage in FIG. 5, an instruction decoder 13 and an instruction issuance control unit 14 operate. The instruction decoder 13 receives the instruction code from the instruction buffer 12, and analyzes a type of the instruction and necessary execution resources. Then, the instruction decoder 13 outputs an analysis result to the instruction issuance control unit 14, the branch control unit 22 and an instruction completion control unit 18.

The instruction issuance control unit 14 has a structure of a reservation station. The reservation station looks at, e.g., dependency of the register that is referred to for the instruction, and thus determines, from an update status of the register having the dependency and from an execution status of the instruction that involves using the same execution resources, whether the execution resources are capable of executing the instruction or not. Then, the reservation station outputs items of information needed for executing the instruction such as a register number and an operand address to each of the execution resources capable of the execution thereof. Furthermore, the instruction issuance control unit 14 takes a role of a buffer to store the instruction till reaching an execution-enabled status. An instruction address buffer 21 stores the instruction fetch address that is output from the instruction fetch control unit 11.

At the instruction execution stage, the execution resources such as the computing unit 15, a (primary) operand cache 16 and the branch control unit 22 operate. The computing unit 15, according as the program is executed, receives the data from the register 17 and the operand cache 16, and performs an arithmetic operation corresponding to the instruction such as four arithmetic operations, a logical operation, a trigonometric function operation and an address calculation. Then, the computing unit 15 outputs an arithmetic result to the register 17 and the operand cache 16. The operand cache 16, similarly to the instruction cache 24, stores a part of the data of the secondary cache 25. The operand cache 16, upon a load instruction, executes loading the data into the computing unit 15 and the register 17 from the memory 3-1 etc. Moreover, the operand cache 16, upon a store instruction, executes storing the data in the memory 3-1 etc from the computing unit 15 and the register 17. Each of the execution resources outputs instruction execution complete notification (COMPLETE) to the instruction completion control unit 18.

The branch control unit 22 has the structure of the reservation station. Note that the reservation station within the branch control unit 22 is termed a branch reservation station 22A (see FIG. 6). The branch control unit 22 (the branch reservation station 22A) receives the type of the branch instruction from the instruction decoder 13, the branch instruction address synchronizing with the instruction decoder 13 from the instruction address buffer 21, and the branch destination address and a signal of the arithmetic result etc becoming a branch condition from the computing unit 15. Then, the branch reservation station 22A stores each of the signals on a per branch instruction basis. The branch control unit 22 determines that the branch is set up if the acquired arithmetic result satisfies the branch condition but determines that the branch is not set up if the acquired arithmetic result does not satisfies the branch condition, thereby establishing the branch direction. Further, in the branch control unit 22, the branch reservation station 22A determines whether or not the branch address is coincident with the branch direction in the arithmetic result and in the predictive branch destination given when making the branch prediction. Moreover, the branch control unit 22 also controls a sequence relation of the branch instructions.

The branch reservation station 22A registers the branch direction and the branch destination address given when making the branch prediction in entries. Then, the branch reservation station 22A, after verifying the coincidence of the arithmetic result with the prediction, replaces the entry on the basis of the arithmetic result. If the arithmetic result is coincident with the prediction, the branch reservation station 22A outputs a branch instruction “COMPLETE” to the instruction completion control unit 18. Whereas if the arithmetic result is not coincident with the prediction, the branch reservation station 22A outputs, together with the branch instruction “COMPLETE”, a cancelling request (which will hereinafter be referred to as a speculative execution instruction cancelling request due to other factors in the present working example) of the subsequent instruction and a re-instruction fetch request to the instruction completion control unit 18. This is because the non-coincidence of the arithmetic result with the prediction implies the failure in the branch prediction. Moreover, the branch reservation station 22A, if the set-up of the branch is established, outputs the branch destination address of the arithmetic result from the entry of the branch reservation station 22A outputting the branch instruction “COMPLETE” to the program counter control unit 19.

At the instruction complete stage, the instruction completion control unit 18, the register 17, the program counter control unit 19 and a branch history updating unit 23 operate. The instruction completion control unit 18 stores the types of the instructions received from the instruction decoder 13 sequentially in a commit stack entry. The instruction completion control unit 18 executes, based on a COMPLETE signal received from each instruction execution resource, an instruction complete (COMMIT) process in the sequence of the instruction codes stored in the commit stack entry. For example, the instruction completion control unit 18 outputs a register update indication to the register 17 and an update indication of the program counter to the program counter control unit 19.

The register 17, upon receiving the register update indication from the instruction completion control unit 18, executes updating the register value on the basis of the data of the arithmetic result received from the computing unit 15 and the operand cache 16.

The program counter control unit 19 receives the COMMIT signal of the instruction and the type of the COMMITTED instruction from the instruction completion control unit 18 and also the branch destination address from the branch control unit 22. The program counter control unit 19, when receiving the COMMIT signal of the branch instruction from the instruction completion control unit 18, sets the branch destination address received from the branch control unit 22 in the program counter. Further, the program counter control unit 19, when receiving the COMMIT signal of an instruction other than the branch instruction, adds the program counter value corresponding to a COMMITTED instruction count. The updated program counter value represents an address of the instruction to be COMMITTED next.

The branch history updating unit 23 generates, based on the result of the branch arithmetic operation that is received from the branch control unit 22, history update data of the branch prediction unit 20, and outputs the generated history update data to the branch prediction unit 20, thereby updating the history of the branch prediction unit 20.

In the working example, as illustrated in FIG. 6, the instruction address is the 64-bit address. Further, in the working example, the processor 1 encodes the high-order 32 bits in the 64 bits of the instruction address into a 3-bit signal (which will hereinafter be called “H32CODE”). It does not, however, mean that the bit count of H32CODE into which the high-order 32 bits are encoded is limited to the 3 bits. In FIG. 6, a 2-tuple of H32CODE and the 32 bits of the low-order address is exemplified such as [2:0] [31:0]. Moreover, the 64-bit address not encoded is exemplified by [63:0]. Accordingly, e.g., the 2-tuple, i.e., [2:0] [31:0], of H32CODE and the 32 bits of the low-order address is stored in the branch history of the branch prediction unit 20.

Then, the processor 1 propagates a combination of H32CODE into which the high-order 32 bits of the instruction address are encoded and the low-order 32 bits through an instruction execution pipeline. Herein, the instruction execution pipeline includes, e.g., the instruction fetch control unit 11, the instruction address buffer 21, the branch reservation station 22A, a program counter 19A, the branch history updating unit 23 and the branch prediction unit 20, etc. Then, the processor 1, in the component using the high-order 32 bits of the instruction address, performs the conversion into the high-order address by decoding the propagated H32CODE.

In the working example, an encoder of H32CODE (which will hereinafter be referred to as an H32 encoder 7) and a decoder of H32CODE (which will hereinafter be referred to as an H32 decoder 8) execute the H32CODE conversion by referring to a common high-order address table. The high-order address table connotes a table to store an associative relation between H32CODE and the high-order address, in which each entry contains H32CODE and the 32-bit address. Herein, the processor 1 may take a configuration (example 1 of configuration) to use one table as the high-order address table shared among all of the H32 decoders 8 and the H32 encoders 7. Further, the processor 1 may take a configuration (example 2 of configuration) in which each of the H32 decoders 8 and the H32 encoders 7 has a small-scale table, and update timing of all the tables are synchronized. In the working example, the processor 1 adopts the example 2 of the configuration.

Moreover, when the processor 1 adopts the SMT method, such a configuration is also considered that the control is done by providing the high-order address table with individual tables on the thread-by-thread basis. In the working example, however, the high-order address table shall be shared between the threads by way of the efficient configuration with a packaging area being small.

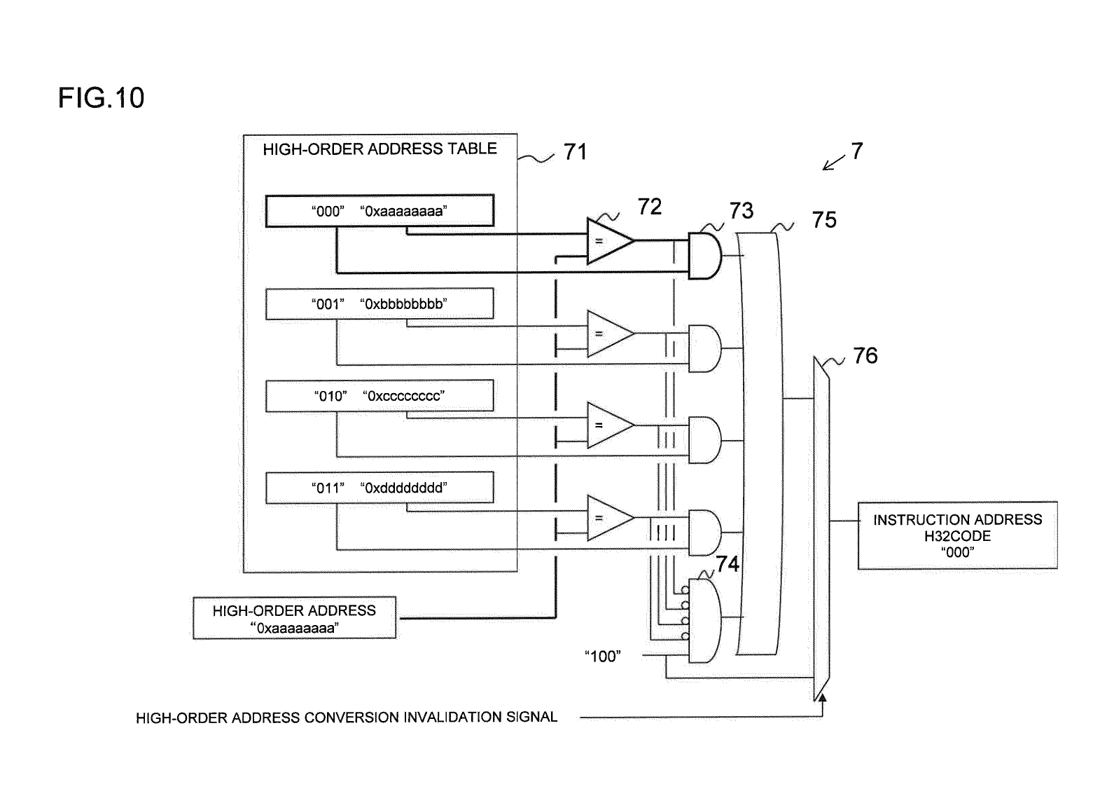

FIG. 10 illustrates a configuration of the H32 encoder 7. The H32 encoder 7, with the high-order address being inputted, compares the 32-bit address of each of the entries registered in a high-order address table 71 within the H32 encoder 7 with the inputted high-order address. Then, the H32 encoder 7 outputs the code (H32CODE) registered in the coincident entry as an encoding result. The H32 encoder 7 is one example of an encoding unit. Moreover, the high-order address table 71 is one example of an associative relation storage unit.

In the example of FIG. 10, the H32 encoder 7 includes the high-order address table 71 and a selection circuit which is connected the respective entries of e high-order address table 71 and selects and outputs the codes (H32CODE) registered in the high-order address table 71. The selection circuit includes, e.g., a comparator 72 and a 2-input AND gate 73. The comparator 72 compares the high-order address registered in the associated entry of the high-order address table 71 with the high-order address inputted to the H32 encoder 7. As a result of the comparison, if the high-order address registered in the associated entry of the high-order address table 71 is coincident with the high-order address inputted to the H32 encoder 7, the comparator sends a true (ON, “1”) signal to one input terminal of the 2-input AND gate 73. Accordingly, the comparator 72 uses, as a reference signal, the high-order address registered in the associated entry of the high-order address table 71.

A value (bit pattern) of the code (H32CODE) registered in the associated entry of the high-order address table 71 with the high-order address being compared by the comparator 72 is inputted to the other input terminal of 2-input AND gate 73. As described above, the code (H32CODE) is a code for encoding the 32-bit high-order address with the small bit count, i.e., the 3 bits in this example. Accordingly, the AND gate 73 receiving the input of the true (ON) signal from the comparator 72 outputs the code (H32CODE) registered in the associated entry of the high-order address table 71, which is inputted from the other input terminal. Further, the AND gate 73 receiving an input of a false (OFF) signal from the comparator 72 is cut off. Therefore, the AND gate 73 does not output the code (H32CODE) registered in the associated entry of the high-order address table 71, which is inputted from the other input terminal. Namely, FIG. 10 conceptually illustrates the AND gate 73, however, more specifically, it may be sufficient that the selection circuit includes a switch that is turned ON/OFF by the comparator 72.

On the other hand, a multi-input AND gate 74 outputs a code (H32CODE) “100” when all of the comparison results of the comparator 72 are false (OFF, “0”). The code (H32CODE) “100” is defined as a signal indicating that the high-order address inputted to the H32 encoder 7 is not registered in the high-order address table 71. Furthermore, a multi-input OR gate 75 outputs any one of the plurality of AND gates 73 and the multi-input AND gate 74 to a selector 76.

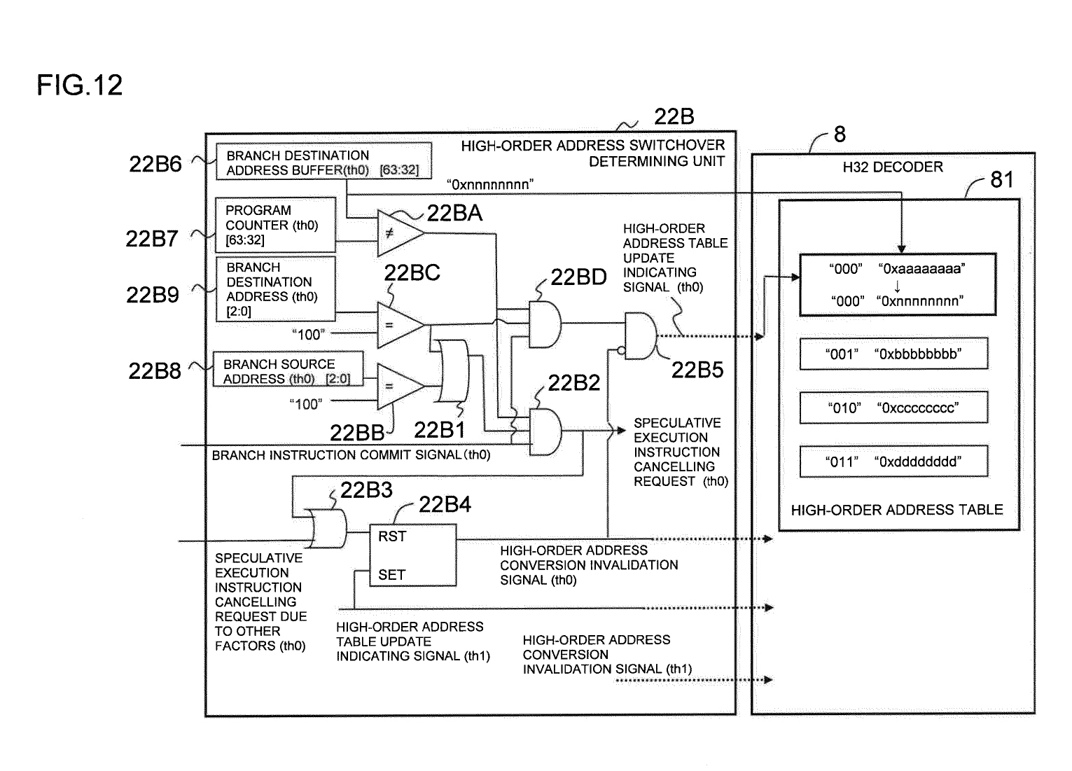

The selector 76 switches over the signal to be selected depending on whether a high-order address invalidation signal is ON or OFF. Herein, the high-order address invalidation signal is a signal generated by a high-order address switchover determining unit in FIGS. 6 and 12. The high-order address invalidation signal is a signal for avoiding an influence exerted by updating the high-order address table 71 in another thread when the processor 1 takes the SMT method.

In FIG. 10, when the high-order address invalidation signal is OFF, the selector 76 selects and outputs an output of the OR gate 75. In this case, the code (H32CODE) registered in the high-order address table or the code “100” is output based on the result of the selection made by the selection circuit. Whereas when the high-order address invalidation signal is ON, the selector 76 outputs the code “100” without depending on the processing result of the selection circuit.

For example, in the case of FIG. 10, the code (H32CODE) of the entry registered with the address coincident with input data “0xaaaaaaaa” is “000”, and hence the H32 encoder 7 outputs “000”. Further, if there is no entry coincident with the inputted high-order address or if the high-order address invalidation signal is “1”, the H32 encoder 7 outputs, as an encoding result, a special code “100” indicating that the comparison result is the non-coincidence.

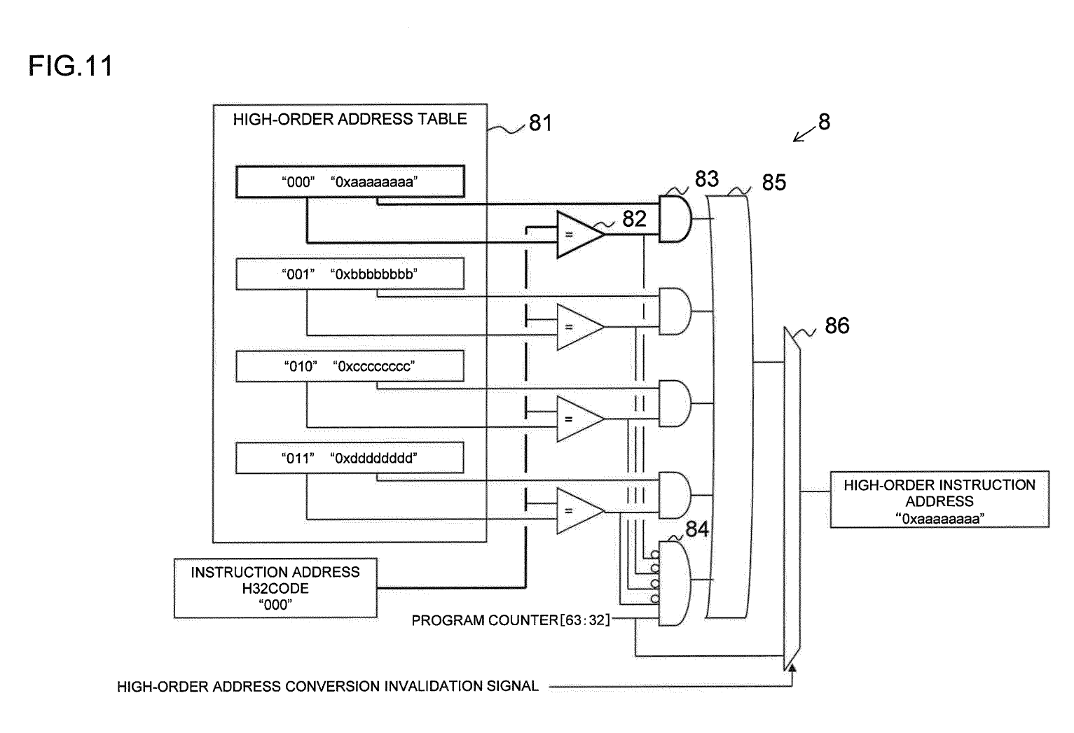

FIG. 11 depicts a configuration of the H32 decoder 8. The H32 decoder 8, with the code (H32CODE) being inputted, compares the code (H32CODE) of each of the entries registered in the high-order address table within the H32 decoder 8 with the inputted code (H32CODE), and outputs, as a decoding result, the 32-bit high-order address registered in the coincident entry.

In the example of FIG. 11, the H32 decoder 8 includes a high-order address table 81 and a selection circuit which is connected to the respective entries of the high-order address table 81 and selects and outputs the high-order addresses registered in the high-order address table 81. The H32 decoder 8 is one example of a decoding unit. Moreover, the high-order address table 81 is one example of an associative relation storage unit.

The selection circuit includes, e.g., a comparator 82 and an 2-input AND gate 83. The comparator 82 compares the code (H32CODE) registered in the associated entry of the high-order address table 81 with the code (H32CODE) inputted to the H32 decoder 8. As a result of the comparison, if the code (H32CODE) registered in the associated entry of the high-order address table 81 is coincident with the code (H32CODE) inputted to the H32 decoder 8, the comparator 82 sends the true (ON, “1”) signal to one input terminal of the 2-input AND gate 83. Accordingly, the comparator 82 uses the code (H32CODE) registered in the associated entry of the high-order address table 81 by way of a reference signal.

A value (bit pattern) of the high-order address registered in the associated entry of the high-order address table 81, which is compared by the comparator 82, is inputted to the other input terminal of the 2-input AND gate 83. Accordingly, the AND gate 83 receiving the input of the true (ON) signal from the comparator 82 outputs the high-order address registered in the associated entry of the high-order address table 81, which is inputted from the other input terminal. That is, the code (H32CODE) is decoded and thus converted into the high-order address. Further, the AND gate 83 receiving the input of the false (OFF, “0”) signal from the comparator 82 is cut off. In this case, the AND gate 83 does not output the high-order address registered in the associated entry of the high-order address table 81, which is inputted from the other input terminal. Accordingly, FIG. 11 also, similarly to FIG. 10, conceptually illustrates the AND gate 83, however, to be more specific, it may be sufficient that the selection circuit includes a switch which is turned ON/OFF by the comparator 82.

Whereas when all of the comparison results of the comparator 82 are false (OFF), a multi-input AND gate 84 outputs the high-order 32 bits of the program counter value. Furthermore, a multi-input OR gate 85 outputs any one of outputs of the plurality of AND gates 83 and the multi-input AND gate 84 to the selector 86.

The selector 86 switches over the signal to be selected depending on whether the high-order address invalidation signal is ON or OFF. Namely, if the high-order address invalidation signal is OFF, the selector 86 selects and outputs an output of the OR gate 85. In this case, the high-order address registered in the high-order address table or the high-order 32 bits of the program counter value are output based on the result of the selection made by the selection circuit. Whereas if the high-order address invalidation signal is ON, the selector 86 outputs the high-order 32 bits of the program counter value without depending on the processing result of the selection circuit.

For example, in the case of FIG. 1, the 32-bit address of the entry registered with the code (H32CODE) coincident with input data “000” is “0xaaaaaaaa”, and hence the H32 decoder 8 outputs “0xaaaaaaaa” as a decoding result with respect to the code (H32CODE) “000”. Further, If there is no entry coincident with the inputted code (H32CODE) or if the high-order address conversion invalidation signal is “1”, the H32 decoder 8 deems that the comparison result is not coincident and outputs, as the decoding result, the high-order address of the program counter 19A, which is defined as the instruction address in the process of the execution underway.

In FIG. 6, codes 8-1, 8-2 are used for distinguishing between the plurality of H32 decoders 8. Codes 7-1, 7-2 are employed for distinguishing between the plurality of H32 encoders 7. For instance, the instruction fetch control unit 11, which has the H32 decoder 8-1, selects the code H32CODE used next for the instruction fetch from the codes H32CODE received from the branch prediction unit 20, the branch control unit 22 and the program counter control unit 19 and the code H32CODE used for the instruction fetch last time as described above, and the H32 decoder 8-1 makes the conversion into the high-order address. The instruction fetch control unit 11 executes the instruction fetch with the post-conversion address serving as the high-order address of the fetch address. If the entry coincident with H32CODE does not exist in the high-order address table 81, the H32 decoder 8-1 outputs the high-order bits of the program counter, which indicate the instruction address in the execution underway at that point of time. Accordingly, the instruction fetch control unit 11 executes the instruction fetch in a way that sets the high-order bits of the program counter as the high-order address of the instruction fetch address. Thus, if the entry coincident with H32CODE does not exist in the high-order address table 81, there is a possibility that the instruction fetch address is erroneous. However, the cache can be refrained from being filled out by using the high-order address of the instruction address in the execution underway as the instruction fetch address. This is because there is a case where iterative executions in the vicinity of the specified address are done in the execution of the program. Note that the case where the H32 decoder 8-1 cannot convert H32CODE into the high-order address in the instruction fetch control unit 11, implies an assumption of a case in which H32CODE in the branch history stored in the branch prediction unit 20 is to be updated at a point of time when making the branch prediction. The code H32CODE in the branch history stored in the branch prediction unit 20 is updated at the point of time when making the branch prediction, in which case such a possibility decreases that the branch prediction gets successful, however, the information processing apparatus can recognize that the branch prediction does not hit.

Further, as in FIG. 6, the branch control unit 22 includes an H32 encoder 7-1 which converts the high-order address of the branch address computing result obtained from the computing unit 15 into the code H32CODE. The branch control unit 22 registers the post-converting H32CODE as the branch destination address in the branch reservation station 22A. Moreover, the branch control unit 22 verifies the coincidence with the computing result by determining whether the branch destination address given when making the branch prediction is correct or not. The branch destination address is checked by comparing the code H32CODE, into which the H32 encoder 7-1 converts a checking result about the high-order address of the branch destination address, with the code H32CODE given when making the branch prediction. Furthermore, the branch control unit 22 includes a high-order address switchover control unit 22B which determines whether the high-order address of the branch destination changes or not.

FIG. 12 illustrates a configuration of the high-order address switchover control unit 22B. The high-order address switchover control unit 22B is one example of a switchover determining unit. The high-order address switchover control unit 22B includes a branch destination high-order address buffer 22B6 that retains the high-order address of the branch destination address before COMMITTING, a high-order address table update indicating signal generation logic, a speculative execution instruction cancelling request generation logic due to the non-coincidence of the high-order address and a high-order address conversion invalidation signal retaining circuit 22B4.

The branch destination high-order address buffer 22B6 retains, e.g., the high-order 32 bits of the branch destination address computed by the computing unit 15. The branch destination high-order address buffer 22B6 retains the high-order address for updating the high-order address tables 81, 71, etc. A case of updating the high-order address tables 81, 71 is assumed to be such a case that the high-order address of the branch destination changes from a high-order address of a branch source and would be a new high-order address not registered in the high-order address tables 81, 71. In this case, the new high-order address will have been calculated by the computing unit 15.

If the high-order address table update indicating signal generation logic outputs “true” (ON, “1”), the high-order 32 bits of the branch destination address retained by the branch destination high-order address buffer 22B6 are registered in the high-order address table 81 of the H32 decoder 8 and in the high-order address table 71 of the H32 encoder 7 in the way of being associated with the code H32CODE. FIG. 12, however, illustrates a path for the registration in the high-order address table 81 of the H32 decoder 8.

The high-order address table update indicating signal generation logic of the high-order address switchover determining unit 22B will be explained by taking FIG. 12 for example. The high-order address switchover determining unit 22B includes a program counter buffer (which will hereinafter be simply termed the PCU buffer 22B7) that retains the high-order bits of the program counter value at the present, a branch source address code buffer (which will hereinafter be simply termed the branch source code buffer 22B8) that retains the code H32CODE associated with the high-order 32 bits of the branch source address, and a branch destination address code buffer (which will hereinafter be simply termed the branch destination code buffer 22B9) that retains the code H32CODE associated with the high-order 32 bits of the branch destination address. Herein the “branch source address” connotes, i.e., a program counter value. Further, the “branch destination address” connotes, e.g., a branch destination address calculated by the computing unit 15.

Note that in FIG. 12, a thread number (th0) is described in each of the branch destination high-order address buffer 22B6, the PCU buffer 22B7, the branch source code buffer 22B8, and the branch destination code buffer 22B9. Moreover, the thread number (th0) is also described in each of a high-order address conversion invalidation signal and also a speculative execution instruction cancelling request due to other factors. The thread number (th0) means the thread concerned.

On the other hand, a high-order address update indicating signal (th1) is also described in FIG. 12. The high-order address update indicating signal (th1) implies a signal from another thread. That is, in FIG. 12, a variety of registers are multiplexed for being compatible with the processor 1 based on the SMT method. Accordingly, if not adopting the SMT method, the high-order address switchover determining unit 22B may not multiplex the branch destination high-order address buffer 22B6, the PCU buffer 22B7, the branch source code buffer 22B8 and the branch destination code buffer 22B9 with the thread numbers (th0 etc). Moreover, if not adopting the SMT method, the high-order address switchover determining unit 22B may not be provided with the high-order address conversion invalidation signal retaining circuit 22B4.

It may be sufficient that the high-order address switchover determining unit 22B acquires the high-order 32 bits of the program counter value at the present from the program counter 19A and retains the acquired high-order 32 bits in the PCU buffer 22B7. Further, the high-order address switchover determining unit 22B acquires the code H32CODE of the branch source from the H32 encoder 7-2 of the program counter 19A, and acquires also the code H32CODE of the branch destination address encoded by the encoder 7-1, which is calculated by the computing unit 15. It may be sufficient that the high-order address switchover determining unit 22B retains the code H32CODE of the branch source and the code H32CODE of the branch destination in the branch source code buffer 22B8 and the branch destination code buffer 22B9, respectively. Then, the high-order address switchover determining unit 22B determines through the comparator 22BA whether or not the high-order 32 bits of e branch destination address that are retained in the branch destination high-order address buffer 22B6 are coincident with the high-order 32 bits of the program counter value that are retained in the PCU buffer 22B7, and, if not coincident, outputs “true” (ON, “1”) to one of the input terminals of the AND gate 22B2 and the AND gate 22BD.

Further, the high-order address switchover determining unit 22B determines through comparators 22BB and 22BC whether at least one of the code H32CODE of the high-order 32 bits of the branch source address that are retain in the branch source code buffer 22B8 and the code H32CODE of the high-order 32 bits of the branch destination address that are retained in the branch destination code buffer 22B9, is a value “100” or not. The high-order address switchover determining unit 22B, with the OR gate 22B1 performing OR operation of a determination result, outputs a result of the OR operation to one input terminal of the AND gate 22B2.

Moreover, a branch instruction COMMIT signal given from the instruction completion control unit 18 is inputted to one input terminal of the AND gate 22B2. Accordingly, the AND gate 22B2 generates a speculative execution instruction cancelling signal under conditions such as:
a condition (1) that the branch destination high-order address of the branch destination high-order address buffer 22B6 is not coincident with the high-order 32 bits of the program counter value;
a condition (2) that at least one of the code H32CODE of the high-order address of the instruction address of the branch instruction and the code H32CODE of the high-order address of the branch destination address is “100”; and
a condition (3) that the branch instruction COMMIT signal is transmitted; and the AND gate 22B2 outputs the generated speculative execution instruction cancelling signal to the respective units of the processor 1 such as the instruction fetch control unit 11, the instruction cache 24, the branch prediction unit 20, the instruction completion control unit 18, the program counter control unit 19 and the branch control unit 22. With the configuration described above, it is feasible to recognize that the branch destination of the branch instruction is not registered in the high-order address table 81 (and the table 71) and that the branch instruction over 4 GB is executed. Hence, the high-order address switchover determining unit 22B can recognize the failure in the branch prediction with respect to the branch instruction that involves conducting the branch over 4 GB.

Further, the high-order address switchover determining unit 22B outputs a result of determining whether a value of the code H32CODE retained in the branch destination code buffer 22B9 is “100” or not to one input terminal of the AND gate 22BD. Moreover, the branch instruction COMMIT signal given from the instruction completion control unit 18 is inputted to one input terminal AND gate 22BD. The AND gate 22BD generates a branch destination high-order address non-coincidence signal by performing an AND operation of outputs of the comparators 22BA, 22BC and the branch instruction COMMIT signal, and outputs the generated signal to one input terminal of the AND gate 22B5.

The AND gate 22B5 performs the AND operation of the branch destination high-order address non-coincidence signal given from the AND gate 22BD and an inverted value (NAND) of the high-order address conversion invalidation signal given from a high-order address conversion invalidation signal retaining circuit 22B4, thereby generating a high-order address update request indicating signal. With the high-order address update request indicating signal, the high-order address of the branch destination address retained in the branch destination high-order address buffer 22B6 is registered in empty entries of the high-order address tables 81, 71. Moreover, if there are no empty entries in the high-order address tables 81, 71, the entries are overwritten in the sequence from the oldest down to the newest. Accordingly, with the high-order address update request indicating signal, the high-order address table 81 of the H32 decoder 8 and the high-order address table 71 of the H32 encoder 7 within the processor 1 are updated. Note that in the processor 1 based on the SMT method, the high-order address update request indicating signal is, e.g., multiplexed on the per thread basis, retained in the register and notified to another thread.

The high-order address conversion invalidation signal retaining circuit 22B4 is, e.g., a latch. A set terminal of the high-order address conversion invalidation signal retaining circuit 22B4 is set by the high-order address update indicating signal (th1) given from the high-order address switchover control unit 22B that is associated with another thread (th1). The high-order address conversion invalidation signal retaining circuit 22B4 is one example of a high-order address conversion invalidation indicating unit.

Further, the high-order address conversion invalidation signal retaining circuit 22B4 is reset by an output signal from the OR gate 22B3 performing the OR operation of, e.g., the speculative execution instruction cancelling request or the speculative execution instruction cancelling request due to other factors. Herein, the “speculative execution instruction cancelling request due to other factors” is a speculative execution instruction cancelling request based on, e.g., the logic other than the high-order address table update indicating signal generation logic of the high-order address switchover determining unit 22B explained above. The speculative execution instruction cancelling request due to other factors is issued from the branch reservation station 22A if the result of the branch prediction by the branch prediction unit 20 is, as described in FIG. 6, in the branch reservation station 22A, not coincident with the result of executing the branch instruction by the computing unit 15.

As described above, the generation of the high-order address table update indicating signal is configured by taking AND of a non-coincidence detection signal (an output of the AND gate 22BD) of the branch destination high-order address and a negative polarity logic of the high-order address conversion invalidation signal in a way that uses the AND gate 22B5. With this configuration, if the high-order address conversion invalidation signal is “true” (ON, “1”), the AND gate 22B5 becomes “false” (OFF, “0”), and, even when the non-coincidence of the branch destination high-order address is detected, the high-order address table is not updated. If the high-order address conversion invalidation signal is “true” (ON, “1”), the H32 encoder 7 outputs “100” irrespective of the result of the comparison between the high-order address table 71 and the code H32CODE. Accordingly, the high-order address has already been registered in the high-order address table 71, and nevertheless the AND gate 22BD operates to issue the update indicating signal for registering again the high-order address in the high-order address table 71. Thereupon, the AND gate 22B5, if the high-order address table update indicating signal is “true” (ON, “1”), makes a hindrance not to issue the high-order address table update indicating signal.

Note that the branch destination high-order address buffer 22B6 of the high-order address switchover determining unit 22B retains the 32 bits of the high-order address of the branch destination address of the oldest instruction in the branch instructions before COMMITTING. The branch control unit 22 outputs the 32 bits of the high-order address of the branch destination address together with the 32 bits of the low-order address of the branch destination address and the code H32CODE to the program counter control unit 19.

Moreover, as in FIG. 6, the high-order address conversion invalidation signals are transmitted respectively to the H32 encoder 7 and the H32 decoder 8 within the processor 1. Furthermore, as in FIG. 6, the program counter control unit 19 includes an H32 decoder 8-2 and an H32 encoder 7-2, and receives the code H32CODE of the branch destination address from the branch control unit 22 when completing the execution of the branch instruction. Then, the program counter control unit 19, as the H32 decoder 8-2 decodes the code H32CODE of the branch destination address received from the branch control unit 22, registers the high-order address as the next instruction address in the program counter 19A. If the high-order address table 81 contains no coincident entry, however, the code H32CODE is “100” in the present working example. In this case, the program counter control unit 19, with a selector 19B selecting not the output of the H32 decoder 8-2 but the output from the branch destination high-order address buffer 22B6, updates the program counter 19A (see FIG. 6). This is because the program counter control unit 19 acquires the correct instruction address of the instruction to be executed next.

Moreover, the program counter control unit 19, as the H32 encoder 7 converts a value of the high-order address in the program counter value into the code H32CODE, transfers the code H32CODE to the instruction fetch address selection logic of the instruction fetch control unit 11.

The high-order address tables 71, 81, etc are updated under the control of the high-order address switchover determining unit 22B described above. The plurality of high-order address tables 71, 81 within the processor is updated at the same timing. An example of how the high-order address table 81 of one H32 decoder 8 is updated will hereinafter be described.

<High-Order Address Table Update Procedure>

A variety of formations about a sequence of updating the entries of the high-order address table 81 are considered, however, the high-order address switchover determining unit 22B in the working example takes, for simplicity, a formation to fill out the entries in the sequence from the oldest entry. The update of the high-order address table 81 is carried out so that the high-order address table given when making the branch prediction is coincident with the high-order address table given when calculating the branch destination address as described above. Therefore, as described above, the processor 1 in the working example detects the non-coincidence of the branch prediction address with the branch destination to which the instruction is actually branched. Then, if detecting the non-coincidence, the processor 1 performs the re-instruction fetch from the correct address and, if the high-order address of the branch destination changes to a value not registered in the high-order address code, updates the high-order address table 81. The following is a description of a high-order address update process based on the hardware configuration of the processor 1 in the working example discussed above.

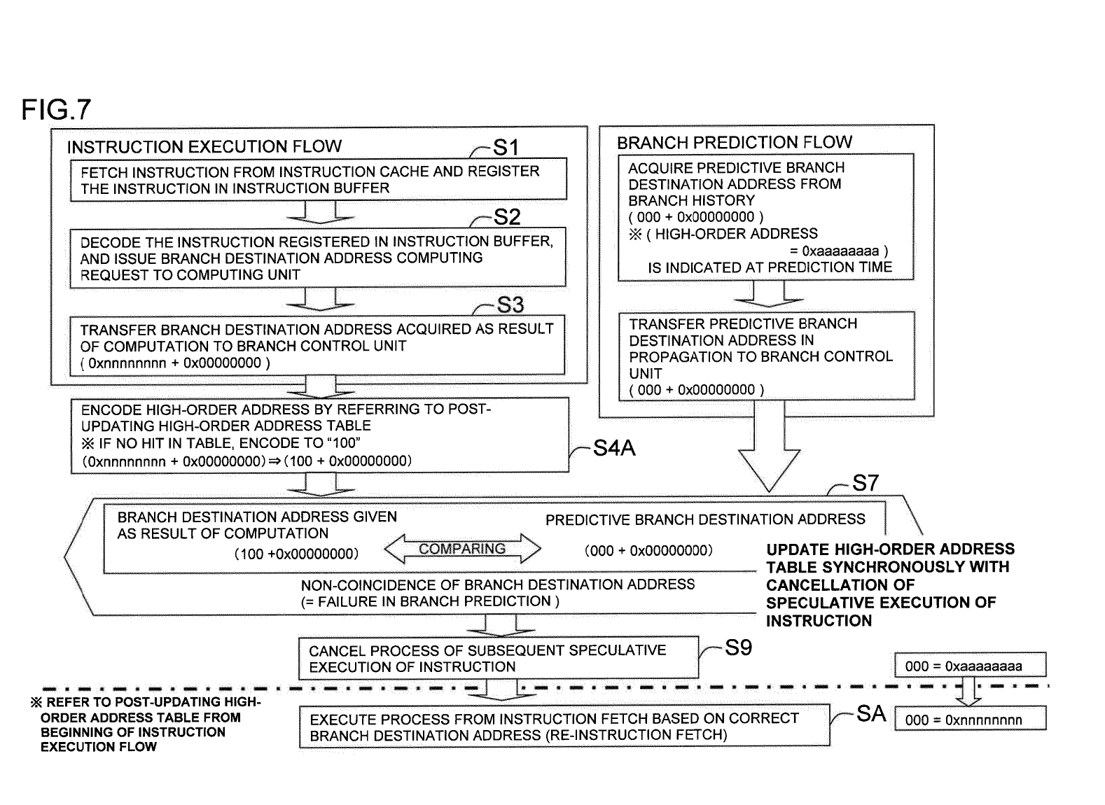

FIG. 7 depicts an operating procedure of updating the high-order address table. Processes in FIG. 7 are the same as the processes in FIGS. 2 and 3 given by way of the comparative example except the process in S4A. Note that when the high-order address is not registered in the high-order address table, the high-order address is encoded into the code “100” indicating “not registered” in the process of S4A in FIG. 7.

With the 32 bits of the low-order address and the code H32CODE, the non-coincidence of the predictive branch destination with the branch destination calculated by the computing unit 15 can be detected by comparing the branch destination stored in the entry of the branch reservation station 22A with the branch destination acquired as the result of the computation. The instruction fetch control unit 11 makes the re-instruction fetch request at the timing when the branch instruction becomes “COMMIT” due to the non-coincidence of the branch destination address. Note that the re-instruction fetch implies the same process as the normal instruction fetch except such a point that the re-instruction fetch is the instruction fetch conducted after cancelling the instruction undergoing the speculative execution. Further, the high-order address switchover determining unit 22B updates the high-order address table at the same timing.

As described above, in response to the speculative execution instruction cancelling request, all the subsequent speculative execution instructions are cancelled, and the branch prediction and the instruction fetch resume by referring to the post-changing high-order address table. Therefore, the instruction fetch with the correct address can be assured. The processes described above are, however the processes in such a case that the code H32CODE is a code other than the special code “100”.

However, the value of the code H32CODE of the branch destination address of the branch instruction, which is calculated by the computing unit 15, is the special code “100” indicating that there are no entries in the high-order address table, in which case the processor 1 cannot assure the coincidence of the high-order address even when the code H32CODE is coincident. Namely, the processor 1 cannot assure if the subsequent branch destination instruction undergoing the speculative execution is correct. This is also the same with the case in which the value of the code H32CODE of the instruction address (program counter value) of the branch instruction is the special code “100” indicating that there are no entries in the high-order address table. If the value of the code H32CODE of the branch destination address is a value other than “100”, the processor 1 continues the speculative execution instruction while the branch prediction remains hitting. Therefore, it is because if there continues the branch instruction with the high-order address changing and even when the value of the code H32CODE of the instruction address of the branch instruction is “100”, such a case exists that the high-order address of the instruction address of the branch instruction is not necessarily coincident with the high-order address of the program counter 19A.

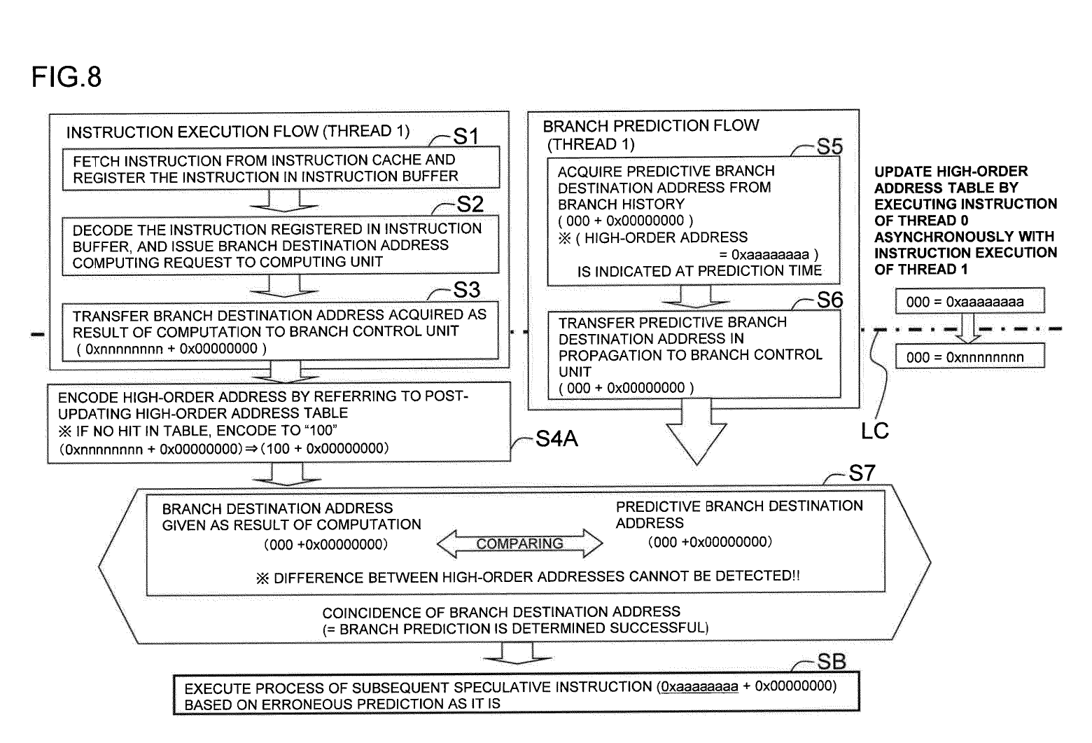

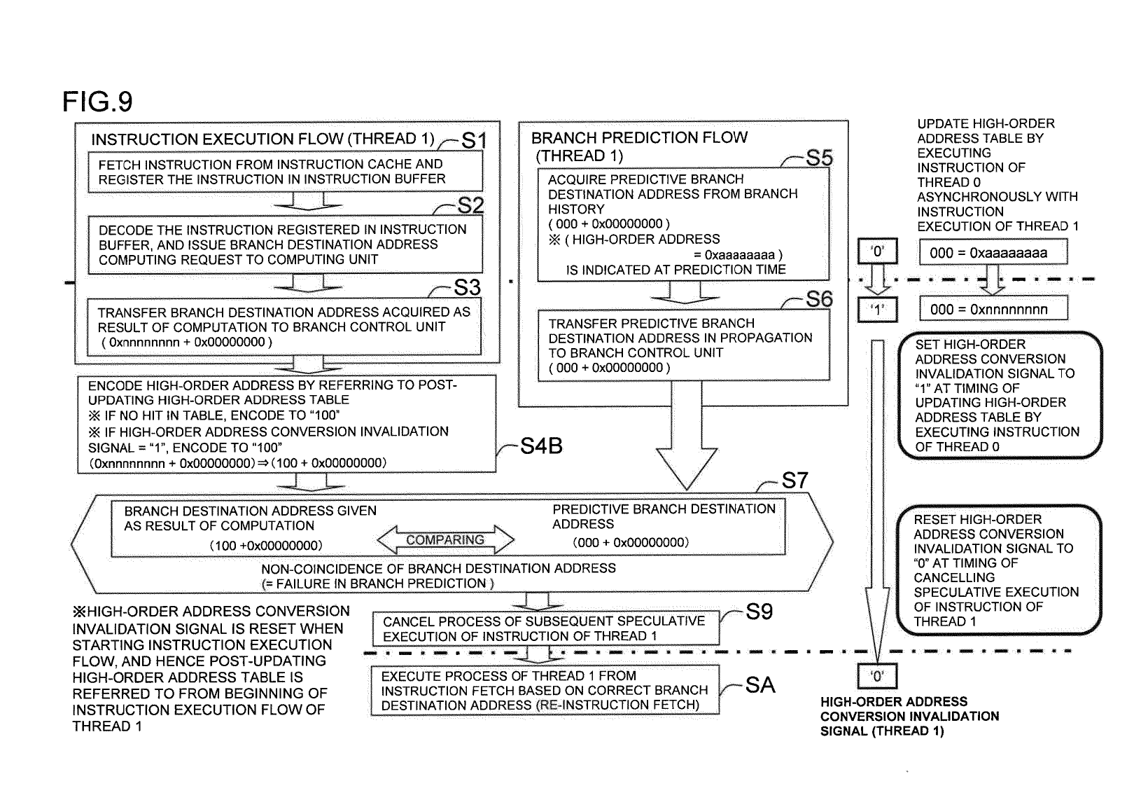

Thereupon, the processor 1 checks whether there is established a condition that the code H32CODE of the instruction address of the branch instruction is “100” or a condition that the code H32CODE of the branch destination address of the branch instruction is “100” (the OR gate 22B1 in FIG. 12). Then, the processor 1 further takes an AND condition with respect to H32CODE=“100” by comparing the branch destination high-order address buffer 22B6 with the program counter 19A. If no entries exist in the high-order address table and if the high-order address of the branch destination address is not coincident with the high-order address of the program counter, it is not assured that the high-order address of the branch destination given when making the branch prediction is correct. Hence, the high-order address switchover control unit 22B issues the speculative execution instruction canceling request at the timing when the branch instruction becomes “COMMIT” due to the non-coincidence of the branch destination address, and further executes updating the high-order address table. Further, the program counter control unit 11 outputs the re-instruction fetch request to the instruction cache 24. Herein, when the high-order address switchover control unit 22B detects the non-existence of the entries in the high-order address table and the non-coincidence of the high-order address, invariably the re-instruction fetch occurs, then the subsequent speculative execution of the instruction is cancelled, and hence it is sufficient for the branch destination high-order address buffer 22B6 to retain, for one instruction, the branch destination high-order address of the oldest branch instruction in the branch instructions before COMMITTING. Note that as illustrated in FIGS. 8 and 9, if the processor 1 is based on the SMT method, it may be sufficient that the branch destination high-order address buffer 22B6 retains, for one instruction, the branch destination high-order address of the oldest branch instruction in the branch instructions before COMMITTING on the thread-by-thread basis.

FIG. 8 illustrates a problem in a case where there is no another-thread invalidation control that accompanies updating the high-order address table in the SMT method. Processes in FIG. 8 are the same as in the case of FIG. 7. In FIG. 8, however, a premise is that the high-order address table of the present thread (th0) is updated by the processing in another thread (th1) on the lower side of a one-dotted chain line LC. Moreover, FIG. 9 depicts a method of solving the problem that accompanies updating the high-order address table in the SMT method. Processes in FIG. 9 are the same as those in FIG. 8 except a process of S4B.

Also in the case of sharing the high-order address table between the threads in the SMT, similarly to FIG. 7, the high-order address switchover determining unit 22B of the processor 1 executes the process of detecting the non-coincidence of the high-order address between the branch destination address given as the result of the computation and the branch destination address that is branch-predicted. Supposing that the high-order address table is updated due to the factor of the thread (th0) in the execution of the instruction underway, however, in the present thread (th1), the high-order address table to be referred to becomes different when making the branch prediction and after performing the computation. Hence, even if the high-order addresses of the branch destinations are different when making the branch prediction and after performing the computation, there is a possibility that the codes H32CODE associated with the respective high-order addresses become identical (S7 in FIG. 8).

In this case, the high-order address switchover determining unit 22B cannot detect the non-coincidence of the branch destination address. Therefore, the subsequent speculative execution instruction based on the erroneous prediction cannot be cancelled. As a result, such a problem arises that the process after branching to the address other than the original branch destination address continues. Such being the case, the high-order address switchover determining unit 22B notifies also another thread of the high-order address table update indicating signals for updating the high-order address tables 81, 71 so that the another thread does not refer to the high-order address tables after updating the high-order addresses. Then, the high-order address switchover determining unit 22B sets the high-order address conversion invalidation signal retaining circuit 22B4 by the high-order address table update indicating signals of which the another thread notifies, and generate the high-order address conversion invalidation signal (FIG. 12). The H32 encoder 7, if the high-order address conversion invalidation signal is “1”, forcibly converts the code H32CODE into “100”. This conversion enables the high-order address table update indicating signal generation logic of the high-order address switchover determining unit 22B to issue the speculative execution instruction cancelling request by detecting the non-coincidence of the branch destination address (FIG. 12). Accordingly, the processor 1 gets enabled to cancel the subsequent speculative execution instruction based on the erroneous prediction (S7-SA in FIG. 9). If the processing once resumes from the instruction fetch, the instruction fetch with the correct address can be assured with respect to the thread concerned.

As discussed above, the high-order address conversion invalidation signal retaining circuit 22B4 can be configured by the 1-bit latch that sets the value to “1” by the high-order address table update indicating signal from another thread and resets the value to “0” by the speculative execution instruction canceling request signal from the self-thread. Moreover, as in FIG. 11, the H32 decoder 8, if the high-order address conversion invalidation signal is “1”, detects the non-coincidence of the branch destination address at all times. It is therefore possible to avoid a status of being unable to detect the non-coincidence of the branch destination address predicted by the branch prediction unit 20 with the branch destination computed by the computing unit 15 in such a case that the high-order address conversion invalidation signal retaining circuit 22B4 updates the high-order address tables 81, 71, etc in another thread.

As described above, the working example has exemplified the configuration of dynamically replacing the high-order address tables 71, 81. It is also, however, feasible to realize the branch prediction getting more efficient as the case may be by mixing the dynamic high-order address patterns and the fixed high-order address patterns in the way of fixedly allocating the codes especially to the patterns that frequently occur.

Moreover, in the working example, the code H32CODE is realized by the 3-bit signals, however, it is possible to keep performance of the efficient branch prediction with a less of changes in a way that increases the concurrently-encoding-enabled address patterns by extending the bit count of the code H32CODE even when there arises a quantity of allocation of the data and the instructions to the 64-bit address space with a prospectively enlarged size of the program. Moreover, in the working example, the description is made in a manner that narrows down to the case where the thread count is “2”, however, because of the configuration to share the high-order address table between the threads, the same configuration can be realized with almost no change of the control even when increasing the thread count in the future. As a matter of course, however, the configuration of the embodiment can be applied to also a processor with the thread count being “1”. In this case, as already mentioned, the high-order address conversion invalidation signal retaining circuit 22B4 in FIG. 12 becomes unnecessary.

As the configuration described above is realized, the processor 1 stores the associative relation between the high-order address of the instruction address and the code H32CODE into which the high-order address is encoded in the high-order address tables 71, 81, dynamically during running the program, converts the high-order address into the code H32CODE, and can efficiently realize the processes of the branch prediction unit 20 etc.

Further, the processor 1 can solve the problem arising due to updating the high-order address tables 71, 81 dynamically during running the program. Namely, the timing of updating the high-order address table is restricted to the occurrence timing of the speculative execution cancelling request, whereby it is feasible to detect the non-coincidence of the branch destination address given as the result of the computation with the branch destination address given when making the branch prediction.

Moreover, the processor 1 encodes the high-order address not registered in the high-order address table 71 into one code, e.g., “100”, thereby enabling the not-registered high-order addresses to be processed uniformly. Moreover, the processor 1 decodes the code H32CODE not registered in the high-order address table 81 back to the high-order address of the program counter value, whereby, e.g., the entry of the instruction cache 24 can be restrained from being filled out.

Further, when the processor 1 adopts the SMT method, the high-order address switchover determining unit 22B in executing another thread underway is notified of the high-order address update indicating signal, whereby another thread can be inhibited from being affected by updating the high-order address tables 71, 81 in one thread.

According to the processor, it is feasible to realize the information processing by expressing the high-order address in a way that uses the smaller number of bits than the bits of the high-order address with respect to the high-order address in the 64-bit address.

### DESCRIPTION OF THE REFERENCE NUMERALS AND SYMBOLS

1 processor
3 memory
5 interconnect control unit
7 H32 encoder
8 H32 decoder
11 instruction fetch control unit
12 instruction buffer
13 instruction decoder
14 instruction issuance control unit
15 computing unit
16 operand cache
17 register
18 instruction completion control unit
19 program counter control unit
20 branch prediction unit
21 instruction address buffer
22 branch control unit
22A branch reservation station
22B high-order address determining unit
23 branch history updating unit
24 instruction cache
25 secondary cache
71, 81 high-order address table

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A processor comprising:
an instruction fetch unit to fetch an instruction from an instruction address defined as an instruction storage source at a fetching stage of the processor repeating an instruction process including the fetching stage of fetching the instruction and an execution stage of executing the instruction;
an associative relation storage unit to register an associative relation between a high-order bit field of the instruction address of the instruction undergoing the instruction process and high-order address information into which the high-order bit field of the instruction address is encoded;
an encoding unit to encode the high-order bit field contained in the instruction address into the high-order address information on the basis of the associative relation; and
a decoding unit to decode the high-order bit field from the high-order address information and the associative relation.

2. The processor according to claim 1, further comprising a switchover determining unit, in a case where the instruction undergoing the instruction process is a branch instruction, to cancel a branch prediction for the branch instruction when the associative relation with respect to at least one of a branch destination address of the branch instruction and a branch source address of the branch instruction is not registered in the associative relation storage unit and the branch instruction branches off to a branch destination in a range in which the high-order address changes, and to update the associative relation when the associative relation with respect to the branch destination address of the branch instruction is not registered in the associative relation storage unit and the branch instruction branches off to the branch destination in the range in which the high-order address changes.

3. The processor according to claim 1, wherein the encoding unit generates a code indicating a not-registered status of the high-order bit field of the instruction address of which the associative relation is not registered.

4. The processor according to claim 1, further comprising a program counter to indicate the instruction address of the instruction fetched by the instruction fetch unit,
wherein the decoding unit decodes the high-order bit field from the instruction address indicated by the program counter with respect to the high-order address information of which the associative relation is not registered.

5. The processor according to claim 1, wherein the associative relation storage unit stores the associative relation in the way of being shared between the threads,
the processor further comprising a high-order address conversion invalidation signal indicating unit to cause the encoding unit to execute a process which is to be executed when the associative relation of the high-order address is not registered and to cause the decoding unit to execute a process which is to be executed when the associative relation of the high-order address information is not registered during a period till the instruction process is redone from the fetching stage in a second thread when updating the associative relation in a first thread.

6. A control method of a processor comprising:
fetching an instruction from an instruction address defined as an instruction storage source at a fetching stage of a processor repeating an instruction process including the fetching stage of fetching the instruction and an execution stage of executing the instruction;
registering, in an associative relation storage unit, an associative relation between a high-order bit field of the instruction address of the instruction undergoing the instruction process and high-order address information into which the high-order bit field of the instruction address is encoded;
encoding the high-order bit field contained in the instruction address into the high-order address information on the basis of the associative relation;
decoding the high-order bit field from the high-order address information on the basis of the associative relation; and
predicting whether an instruction fetched by the instruction fetch unit is a branch instruction or not on the basis of history information to store the high-order address information and a low-order bit field associated with a branch destination address of the branch instruction undergoing the instruction process.
